(19) United States
(12) Patent Application Publication
(10) Pub. No.: US 2011/0010211 A1
(43) Pub. Date: Jan. 13, 2011

(54) AUTOMATICALLY PRESCRIBING TOTAL BUDGET FOR MARKETING AND SALES RESOURCES AND ALLOCATION ACROSS SPENDING CATEGORIES

(76) Inventors: David Cavander, Los Angeles, CA (US); Wes Nichols, Los Angeles, CA (US); Jon Vein, Los Angeles, CA (US); Dominique Hanssens, Los Angeles, CA (US)

Correspondence Address: PERKINS COIE LLP, POST OFFICE BOX 1208, SEATTLE, WA, 98111-1208, US

(21) Appl. No.: 12/541,769

(22) Filed: Aug. 14, 2009

Related U.S. Application Data
(60) Provisional application No. 61/089,382, filed on Aug. 15, 2008.

(51) Int. Cl. G06Q 10/00

(52) U.S. Cl. 705/7

(57) ABSTRACT

In one embodiment, a computer-readable medium is provided for performing a method for automatically prescribing a budget for sales expenses including, determining lift factors for sales expenses and other promotion activities, establishing a relationship between the determined lift factors, budgets for the promotion activities to which the lift factors correspond, and a projected value of the distinguished business outcome; and using the established relationship to solve for a value of the sales expenses budget that tends to optimize the projected value of the distinguished business outcome in accordance with the selected optimization.

### CROSS-REFERENCE TO RELATED APPLICATION(S)

The present application claims the benefit of U.S. Provisional Patent Application No. 61/089,382, filed Aug. 15, 2008 which is incorporated herein by reference in its entirety.

The present application is related to the following applications, each of which is hereby incorporated by reference in its entirety: U.S. Provisional Patent Application No. 60/895,729, filed Mar. 19, 2007, U.S. Provisional Patent Application No. 60/991,147, filed Nov. 29, 2007, U.S. Provisional Patent Application No. 61/084,252, filed Jul. 28, 2008, and U.S. Provisional Patent Application No. 61/084,255, filed Jul. 28, 2008.

### TECHNICAL FIELD

The described technology is directed to the field of automated decision support tools, and, more particularly, to the field of automated budgeting tools.

### BACKGROUND

Marketing communication (“marketing”) is the process by which the sellers of a product or a service—i.e., an “offering”—educate potential purchasers about the offering. Marketing is often a major expense for sellers, and is often made of a large number of components or categories, such as a variety of different advertising media and/or outlets, as well as other marketing techniques. Despite the complexity involved in developing a marketing budget attributing a level of spending to each of a number of components, few useful automated decision support tools exists, making it common to perform this activity manually, relying on subjective conclusions, and in many cases producing disadvantageous results.

In the few cases where useful decision support tools exist, it is typically necessary for the tool's user to provide large quantities of data about past allocations of marketing resources to the subject offering, and the results that that they produced. In many cases, such as in the cases of a new offering, such data is not available. Even where such data is available, it can be inconvenient to access this data and provide it to the decision support tool.

Accordingly, a tool that automatically prescribed an advantageous allocation of funds or other resources to an offering and its various components without requiring the user to provide historical performance data for the offering would have significant utility.

### BRIEF DESCRIPTION OF THE DRAWINGS

FIG. 1 is a high-level data flow diagram showing data flow within a typical arrangement of components used to provide the facility.

FIG. 2 is a block diagram showing some of the components typically incorporated in at least some of the computer systems and other devices on which the facility executes.

FIG. 3 is a table drawing showing sample contents of a library of historical marketing efforts.

FIG. 4 is a display diagram showing a sign-in page used by the facility to limit access to the facility to authorized users.

FIG. 5 is a flow diagram showing a page display generated by the facility in a view/edit mode.

FIGS. 6-9 show displays presented by the facility in order to solicit information about the subject offering for which an overall marketing budget and its distribution are to be prescribed by the facility.

FIG. 10 is a display diagram showing a result navigation display presented by the facility after collecting information about the subject offering to permit the user to select a form of analysis for reviewing results.

FIG. 11 is a display diagram showing a display presented by the facility to convey the optimal total marketing budget that the facility has is determined for the subject offering.

FIG. 12 is a display presented by the facility to show spending mix information. The display includes an overall budget 1201 prescribed by the facility.

FIG. 13 is a process diagram that describes collecting additional offering attribute information from the user.

FIG. 14 is a process diagram showing the derivation of three derived measures for the subject offering: cognition, affect, and experience.

FIG. 15 is a table diagram showing sets of marketing activity allocations, each for a different combination of the three derived attributes shown in FIG. 14.

FIG. 16 is a process diagram showing how the initial allocation specified by the table in FIG. 15 should be adjusted for a number of special conditions 1600.

FIG. 17 is a process diagram showing how the facility determines dollar amount for spending on each marketing activity.

FIG. 18 is a process diagram showing the final adjustment to the results shown in FIG. 17.

FIG. 19 is a display diagram showing a display presented by the facility to portray resource allocation prescriptions made by the facility with respect to a number of related subject offerings, such as the same product packaged in three different forms.

FIGS. 20-23 are display diagrams showing a typical user interface presented by the facility in some embodiments for specifying and automatically collecting data inputs.

FIGS. 24-36B illustrate a first approach to optimizing the allocation of resources to sales activities used by the facility in some embodiments.

FIGS. 37-45B illustrate a second approach to optimizing the allocation of resources to sales activities used by the facility in some embodiments.

### DETAILED DESCRIPTION

A software facility that uses a qualitative description of a subject offering to automatically prescribe both (1) a total budget for marketing and sales resources for a subject offering and (2) an allocation of that total budget over multiple spending categories—also referred to as “activities”—in a manner intended to optimize a business outcome such as profit for the subject offering based on experimentally-obtained econometric data (“the facility”) is provided.

In an initialization phase, the facility considers data about historical marketing efforts for various offerings that have no necessary relationship to the marketing effort for the subject offering. The data reflects, for each such effort: (1) characteristics of the marketed offering; (2) total marketing budget; (3) allocation among marketing activities; and (4) business results. This data can be obtained in a variety of ways, such as by directly conducting marketing studies, harvesting from academic publications, etc.

The facility uses this data to create resources adapted to the facility's objectives. First, the facility calculates an average elasticity measure for total marketing budget across all of the historical marketing efforts that predicts the impact on business outcome of allocating a particular level of resources to total marketing budget. Second, the facility derives a number of adjustment factors for the average elasticity measure for total marketing budget that specify how much the average elasticity measure for total marketing budget is to be increased or decreased to reflect particular characteristics of the historical marketing efforts. Third, for the historical marketing efforts of each of a number groups of qualitatively similar offerings, the facility derives per-activity elasticity measures indicating the extent to which each marketing activity impacted business outcome for marketing efforts for the group.

The facility uses interviewing techniques to solicit a qualitative description of the subject offering from user. The facility uses portions of the solicited qualitative description to identify adjustment factors to apply to the average elasticity measure for total marketing budget. The facility uses a version of average elasticity measure for total marketing budget adjusted by the identified adjustment factors to identify an ideal total marketing budget expected to produce the highest level of profit for the subject offering, or to maximize some other objective specified by the user.

After identifying the ideal total marketing budget, the facility uses the solicited qualitative description of the subject offering to determine which of the groups of other offerings the subject offering most closely matches, and derives a set of ideal marketing activity allocations from the set of per-activity elasticity measures derived for that group.

In some embodiments, the facility considers data received from one or more of a number of types of external sources, including the following: syndicated media, syndicated sales data, internet media, internet behavioral data, natural search query data, paid search activity data, media data like television, radio, print, consumer behavioral data, tracking survey data, economic data, weather data, financial data like stock market, competitive marketing spend data, and online and offline sales data.

In some embodiments, the facility specifically determines an optimal allocation of resources to direct sales activities.

In this manner, the facility automatically prescribes a total marketing resource allocation and distribution for the subject offering without requiring the user to provide historical performance data for the subject offering.

The sales or market response curves determined by the facility predict business outcomes as mathematical functions of various resource drivers:

Sales=F(Any Set of Driver Variables),

where F denotes a statistical function with the proper economic characteristics of diminishing returns

Further, since this relationship is based on data, either time series, cross-section, or both time series and cross-section, the method inherently yields direct, indirect, and interaction effects for the underlying conditions.

These effects describe how sales responds to changes in the underlying driver variables and data structures. Often, these response effects are known as “lift factors.” As a special subset or case, these methods allow reading any on-off condition for the cross-sections or time-series.

There are various classes of statistical functions which are appropriate for determining and applying different types of lift factors. In some embodiments, the facility uses a class known as multiplicative and log log (using natural logarithms) and point estimates of the lift factors.

In certain situations, the facility uses methods which apply to categorical driver data and categorical outcomes. These include the, classes of probabilistic lift factors known as multinomial logit, logit, probit, non-parametric or hazard methods.

In various embodiments, the facility uses a variety of other types of lift factors determined in a variety of ways. Statements about “elasticity” herein in many cases extend to lift factors of a variety of other types.

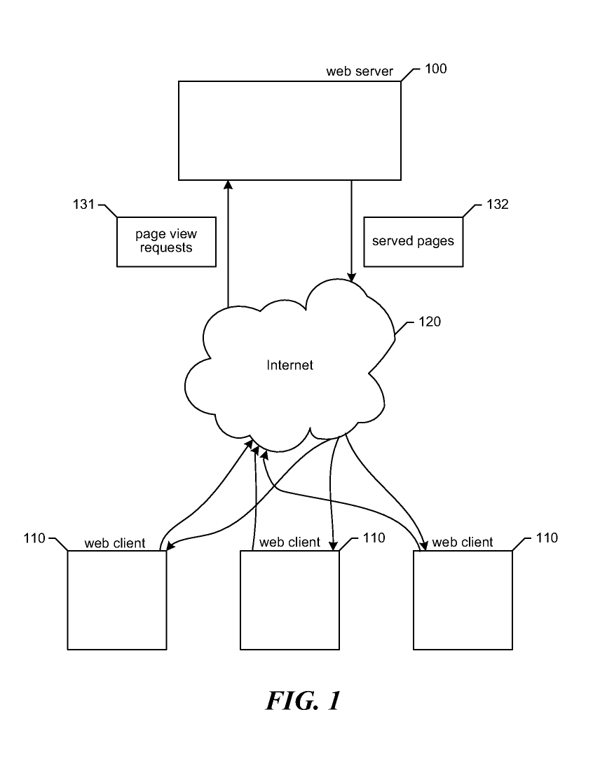

FIG. 1 is a high-level data flow diagram showing data flow within a typical arrangement of components used to provide the facility. A number of web client computer systems 110 that are under user control generate and send page view requests 131 to a logical web server 100 via a network such as the Internet 120. These requests typically include page view requests and other requests of various types relating to receiving information about a subject offering and providing information about prescribed total marketing budget and its distribution. Within the web server, these requests may either all be routed to a single web server computer system, or may be loaded-balanced among a number of web server computer systems. The web server typically replies to each with a served page 132.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different client devices may be used in place of the web client computer systems, such as mobile phones, personal digital assistants, televisions, cameras, etc.

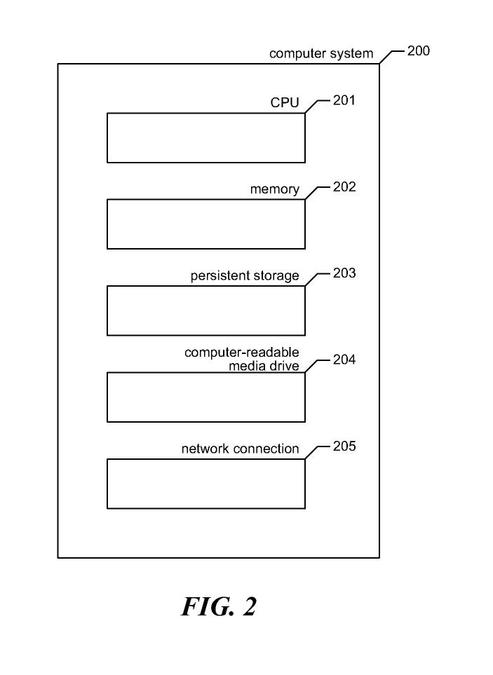

FIG. 2 is a block diagram showing some of the components typically incorporated in at least some of the computer systems and other devices on which the facility executes. These computer systems and devices 200 may include one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable medium; and a network connection 205 for connecting the computer system to other computer systems, such as via the Internet. While computer systems configured as described above are typically used to support the operation of the facility, those skilled in the art will appreciate that the facility may be implemented using devices of various types and configurations, and having various components.

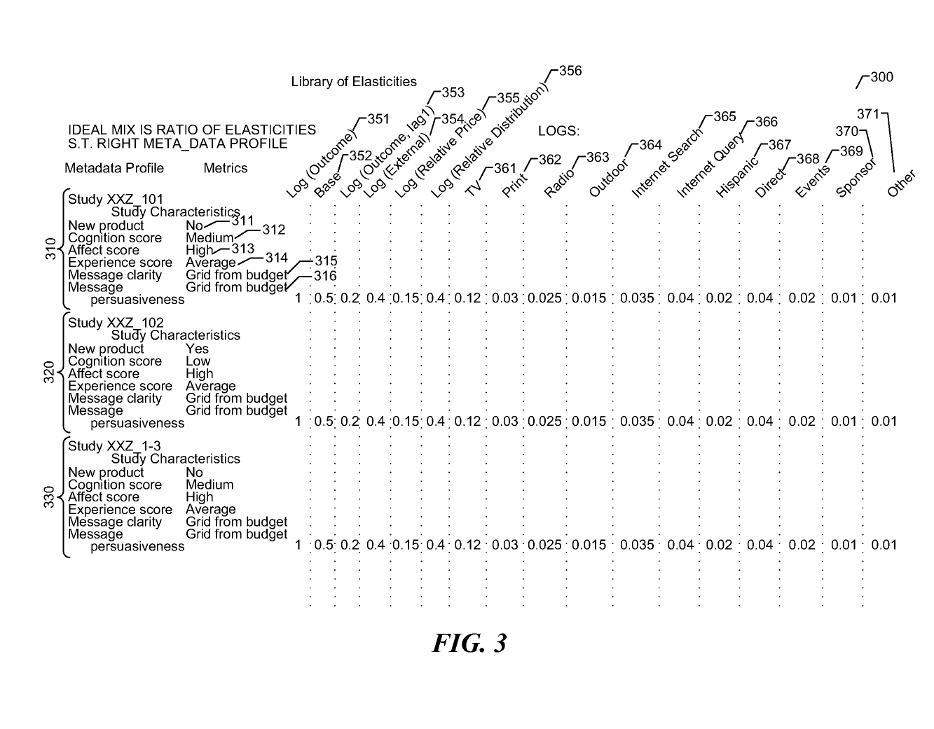

FIG. 3 is a table drawing showing sample contents of a library of historical marketing efforts. The library 300 is made up of entries, such as entries 310, 320, and 330, each corresponding to a set of one or more historical marketing efforts each sharing a similar context. Each entry contains a number of context attribute values that hold true for the historical marketing efforts corresponding to the entry, including values for a new product attribute 311, a cognition score attribute 312, an affect score attribute 313, an experience score 314, a message clarity score 315, and a message persuasiveness score 316. Each entry further contains values for the following statistical measures for the historical marketing efforts corresponding to the entry: log of the outcome 351, base 352, log of outcome with a lag factor 353, log of external 354, log of relative price 355, and log of relative distribution 356. Each entry further contains logs of advertising efficiency values for each of a number of categories, including TV 361, print 362, radio 363, outdoor 364, Internet search 365, Internet query 366, Hispanic 367, direct 368, events 369, sponsorship 370, and other 371.

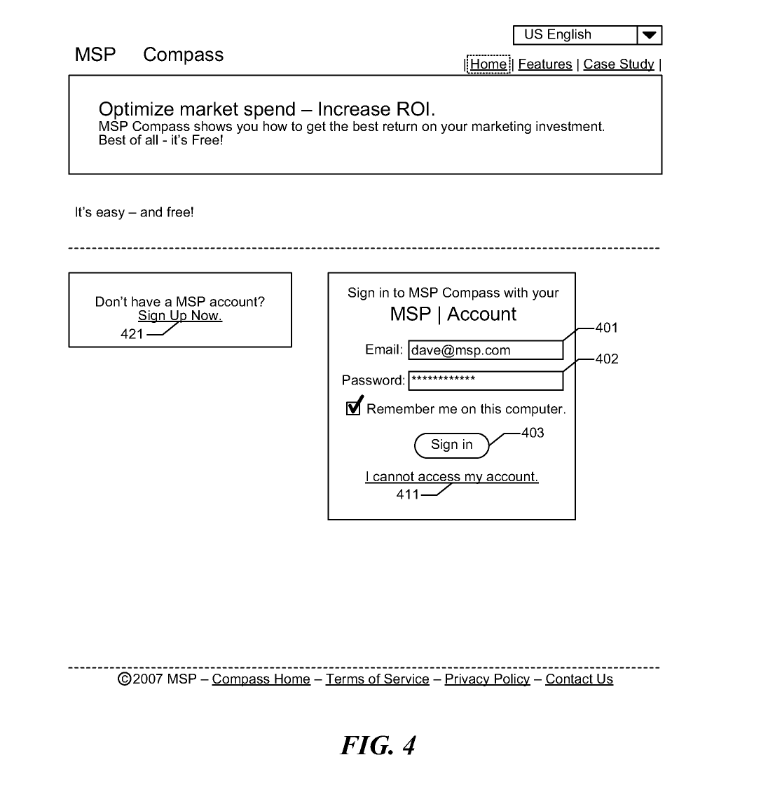

FIG. 4 is a display diagram showing a sign-in page used by the facility to limit access to the facility to authorized users. A user enters his or her email address into field 401, his or her password into field 402, and selects a signing control 403. If the user has trouble signing in this manner, the user selects control 411. If the user does not yet have an account, the user selects control 421 in order to create a new account.

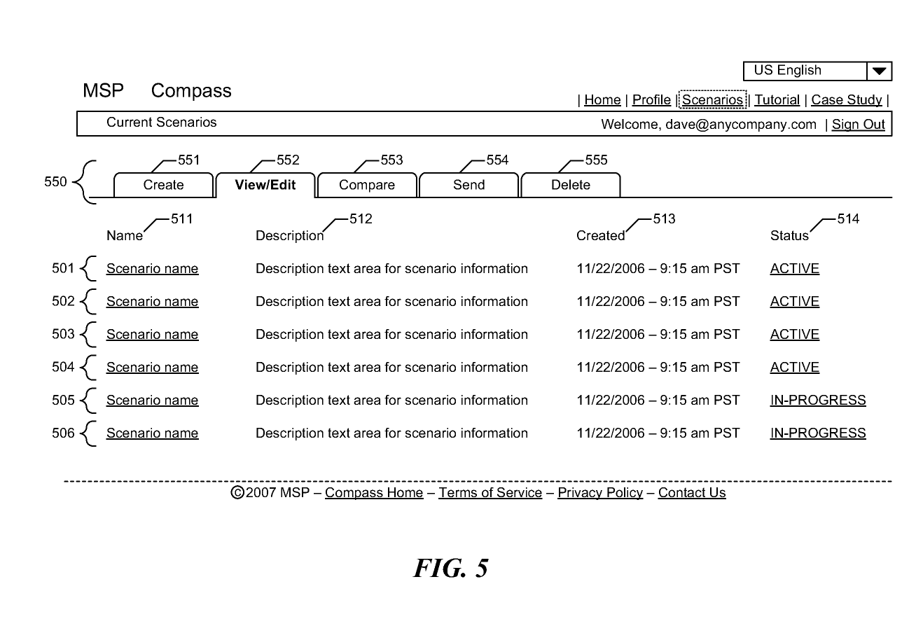

FIG. 5 is a flow diagram showing a page display generated by the facility in a view/edit mode. The display lists a number of scenarios 501-506, each corresponding to an existing offering prescription generated for the user, or generated for an organization with which the user is associated. For each scenario, the display includes the name of the scenario 511, a description of the scenario 512, a date 513 on which the scenario was created, and a status of the scenario. The user may select any of the scenarios, such as by selecting its name, or its status, to obtain more information about the scenario. The display also includes a tab area 550 that the user may use in order to navigate different modes of the facility. In addition to tab 552 for the present view/edit mode, the tab area includes a tab 551 for a create mode, a tab 553 for a compare mode, a tab 554 for a send mode, and a tab 555 for a delete mode. The user can select any of these tabs in order to activate the corresponding mode.

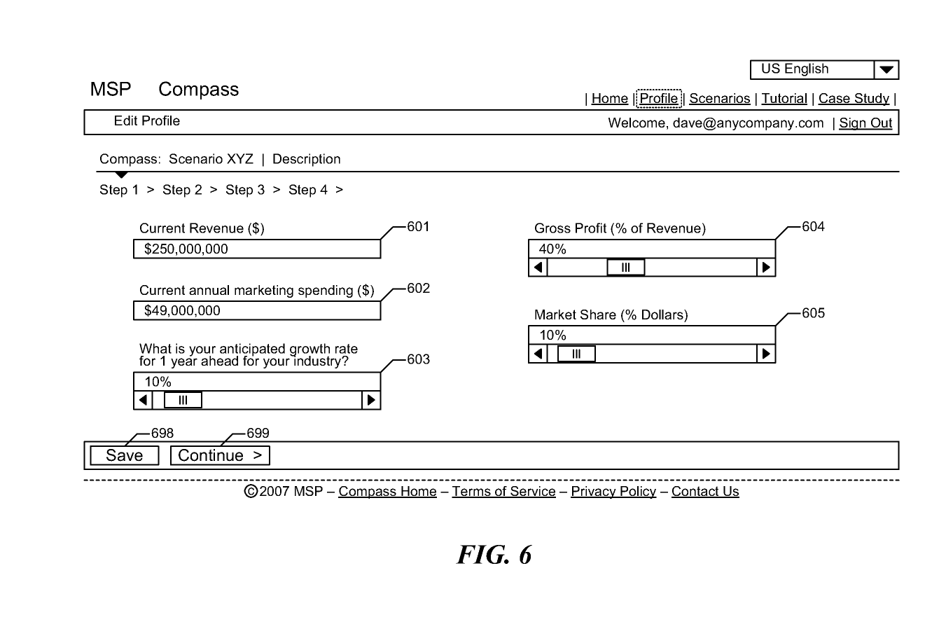

FIGS. 6-9 show displays presented by the facility in order to solicit information about the subject offering for which an overall marketing budget and its distribution are to be prescribed by the facility. FIG. 6 shows controls for entering values for the following attributes: current revenue 601, current annual marketing spending 602, anticipated growth rate for the next year in the industry as a whole 603, gross profit expressed as a percentage of revenue 604, and market share expressed as a percentage of dollar 605. The display further includes a save control 698 that the user can select in order to save the attribute values that they have entered, and a continue control 699 that the user may select in order to proceed to the next display for entering the context attribute values.

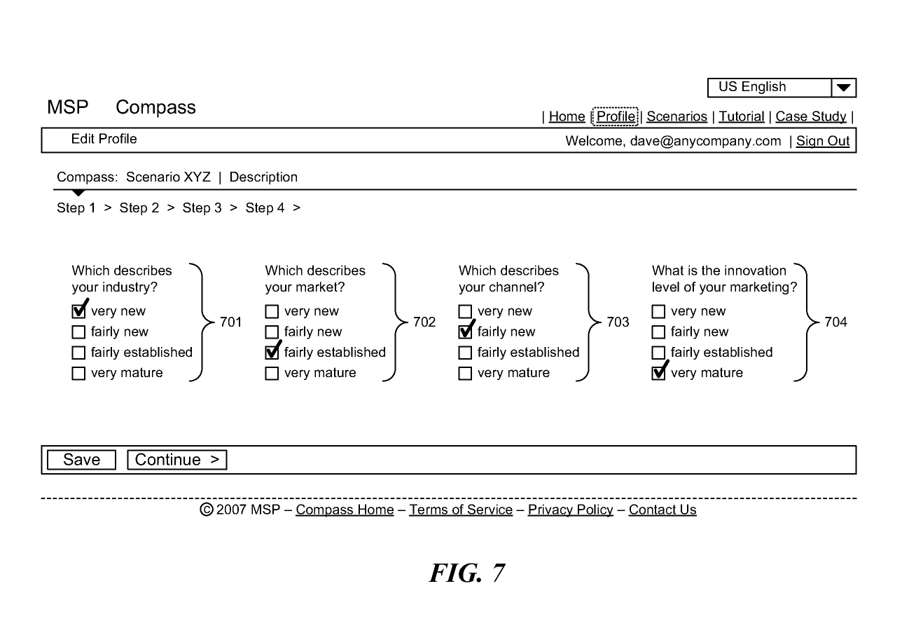

FIG. 7 is a further display presented by the facility to solicit attribute values for the subject offering. It includes controls for inputting values for the following context attributes: industry newness 701, market newness 702, channel newness 703, and marketing innovation 704.

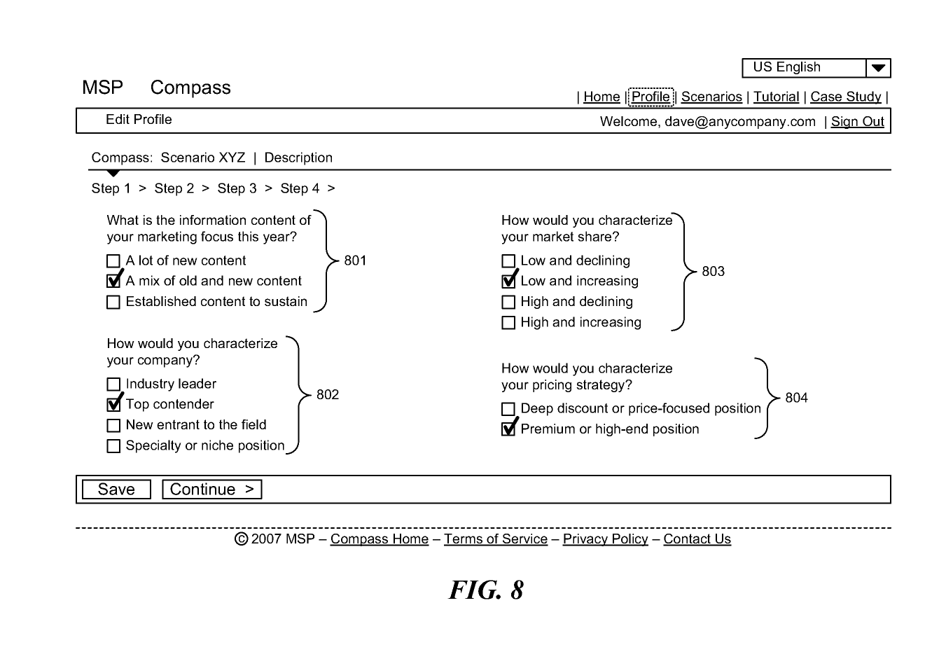

FIG. 8 is a further display presented by the facility in order to solicit attribute values. It has controls that the user may use to enter the values for the following context attributes: newness of marketing information content 801, company position in the market 802, market share 803, and pricing strategy 804.

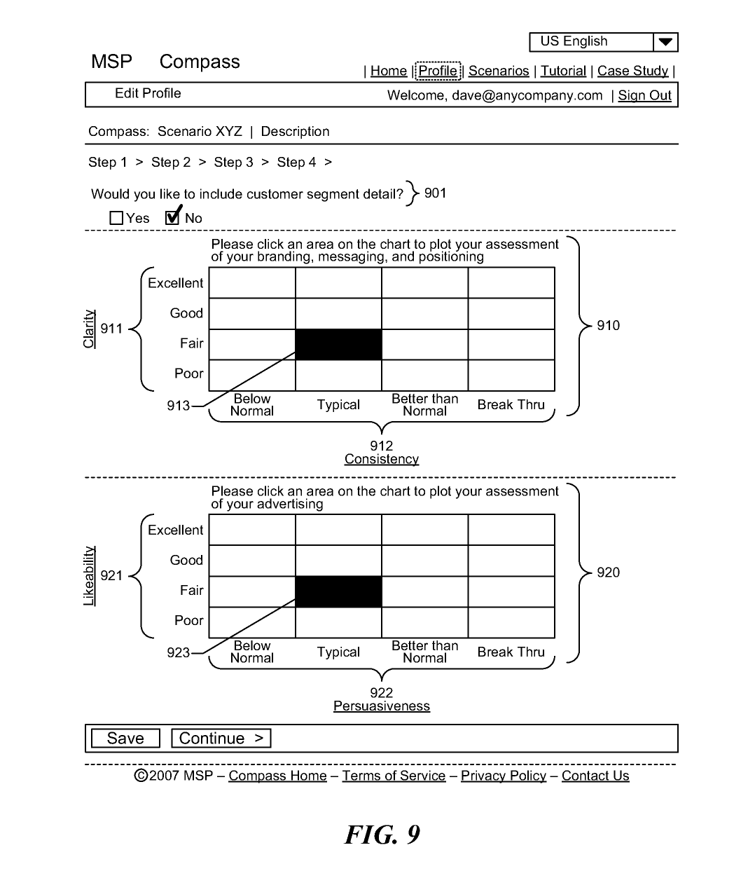

FIG. 9 is a further display presented by the facility in order to solicit attribute values. It contains a control 901 that the user may use to determine whether customer segment detail will be included. The display further contains charts 910 and 920 for specifying values of additional context attributes. Chart 910 can be used by the user to simultaneously specify values for the consistency and clarity of branding messaging and positioning efforts by the company responsible for the subject offering. In order to use chart 910, the user selects a single cell in the grid included in the chart corresponding to appropriate values of both the consistency and clarity attributes. Section 920 is similar, enabling the user to simultaneously select appropriate values for the persuasiveness and likeability of the company's advertising.

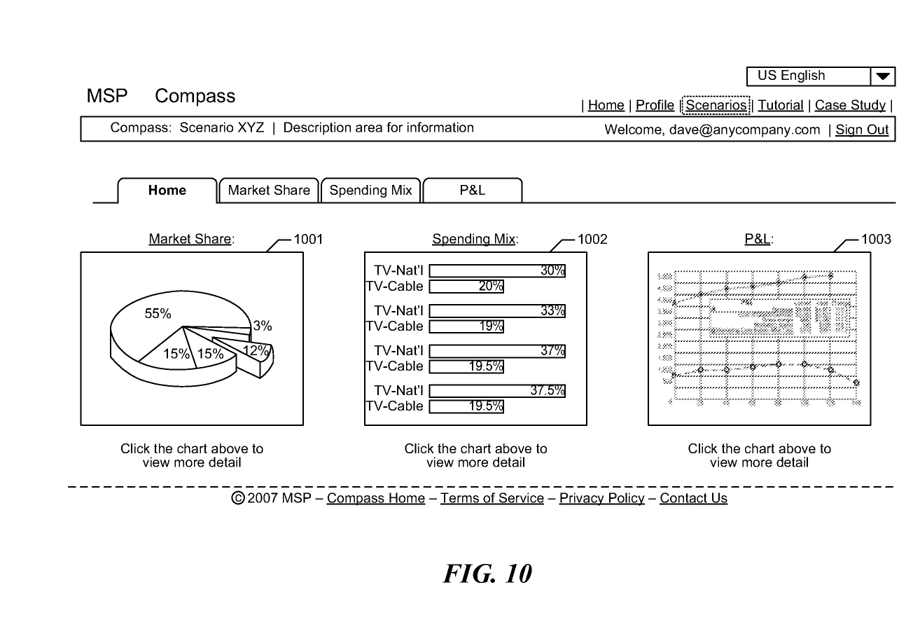

FIG. 10 is a display diagram showing a result navigation display presented by the facility after collecting information about the subject offering to permit the user to select a form of analysis for reviewing results. The display includes a control 1001 that the user may select in order to review market share information relating to the result, a control 1002 that the user may select in order to review spending mix information relating to the result, and a control 1003 that the user may select in order to review profit and loss information relating to the result.

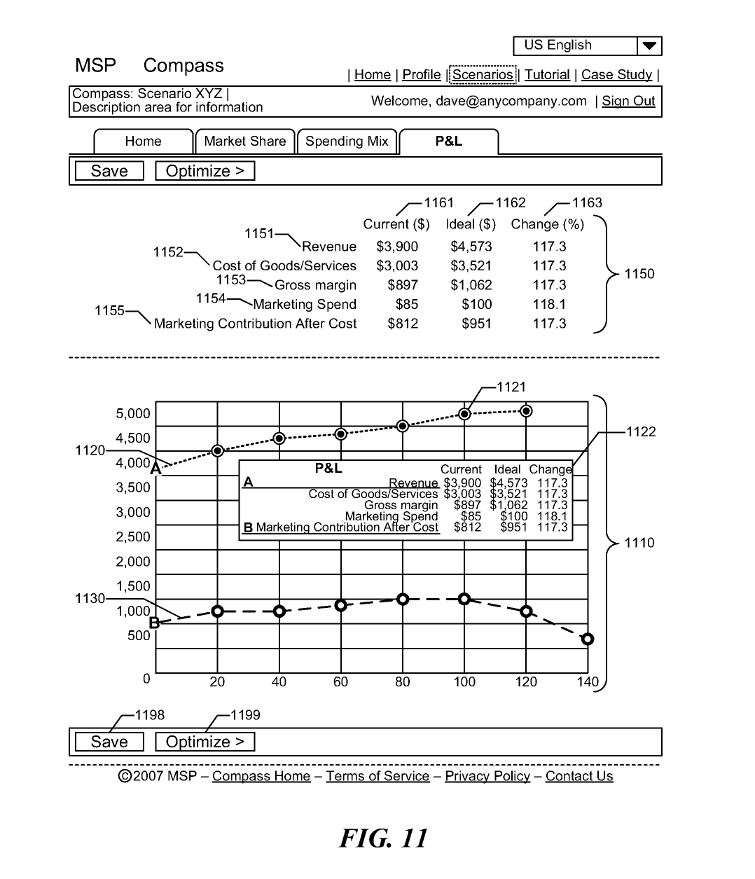

FIG. 11 is a display diagram showing a display presented by the facility to convey the optimal total marketing budget that the facility has determined for the subject offering. The display includes a graph 1110 showing two curves: revenue with respect to total marketing budget (or “marketing spend”) 1120 and profit (i.e., “marketing contribution after cost”) with respect to total marketing budget 1130. The facility has identified point 1131 as the peak of the profit curve 1130 and has therefore identified the corresponding level of marketing spend, $100, as the optimal marketing spend. The height of point 1131 shows the expected level of profit that would be produced by this marketing spend, and the height of point 1121 shows the expected level of total revenue that would be expected at this marketing spend. Table 1150 provides additional information about the optimal marketing spend and its calculation. The table shows, for each of current marketing spend 1161, ideal marketing spend 1162, and delta between these two 1163: revenue 1151 projected for this level of marketing spend; costs of goods and services 1152 anticipated to be incurred at this level of marketing spend; gross margin 1153 to be procured at this level of marketing spend; the marketing spend 1154; and the marketing contribution after cost 1155 expected at this level of marketing spend.

In order to define the profit curve and identify the total marketing budget level at which it reaches its peak, the facility first determines a total marketing budget elasticity appropriate for the subject offering. This elasticity value falls in a range between 0.01 and 0.30, and is overridden to remain within this range. The facility calculates the elasticity by adjusting an initial elasticity value, such as 0.10 or 0.11, in accordance with a number of adjustment factors each tied to a particular attribute value for the subject offering. Sample values for these adjustment factors are shown below in Table 1.

TABLE 1

| | Industry | Marketing | New | Market | Advertising |
|---|---|---|---|---|---|
| | Newness | Innovation | Information | Share | Quality |
| High | .05 | .1 | .05 | −.03 | .04 |
| Medium | 0 | 0 | 0 | 0 | 0 |
| Low | −.02 | −.03 | −.02 | .02 | −.03 |

The industry newness column corresponds to control 701 shown in FIG. 7. For example, if the top check box in control 701 is checked, then the facility selects the adjustment factor 0.05 from the industry newness column; if either of the middle two boxes in control 701 are checked, then the facility selects the adjustment factor 0 from the industry newness column; and if the bottom checkbox in control 701 is checked, then the facility selects the adjustment factor −0.02 from the industry newness column. Similarly, the marketing innovation column corresponds to control 704 shown in FIG. 7, the new information column corresponds to control 801 shown in FIG. 8, and the market share column corresponds to control 803 shown in FIG. 8. The advertising quality column corresponds to charts 910 and 920 shown in FIG. 9. In particular, the sum of the positions of the cells selected in the two graphs relative to the lower left-hand corner of each graph is used to determine a high, medium, or low level of advertising quality.

The facility then uses the adjusted total marketing budget elasticity to determine the level of total marketing budget at which the maximum profit occurs, as is discussed in detail below in Table 2.

TABLE 2
Definitions:
Sales = S
Base = β
Marketing Spend = M
Elasticity = α
Cost of Goods Sold (COGS) = C
Profit = P (P is a function of S, C, and M, as defined in equation 2 below)
Fundamental equation relating Sales to Marketing (alpha and beta will be supplied)
Equation (1): S = β * M^{α}
Equation relating Sales to Profits (C will be known), so that we can substitute for Sales in
equation (1) above and set the program to maximize profits for a given alpha and beta.
Equation (2): P = [S * (1 − C)] − M
Solve Equation (2) for Sales:
$\frac{( P + M )}{( 1 - C )} = S$
Substitute for S in Fundamental Equation:
$\frac{( P + M )}{( 1 - C )} = β * {M}^{α}$
Solve for P as a function of M, C, alpha and beta:
P = [β * M^{a} * (1 − C )] − M
Now we have P as a function of M.
Take derivatives
$\frac{dP}{dM} = ( [ ( 1 - C ) βα ] * {M}^{α - 1} ) - 1$
Set to zero to give local inflection point:
1 = [(1 − C)βα] * M^{α-1}
Solve for M
$M = {( \frac{1}{[ ( 1 - C ) βα ]} )}^{\frac{1}{α - 1}}$
Check sign of second derivative (to see that it is a max not a min)
[(1 − C)βα(α − 1)] * M^{α-2} < 0 ?

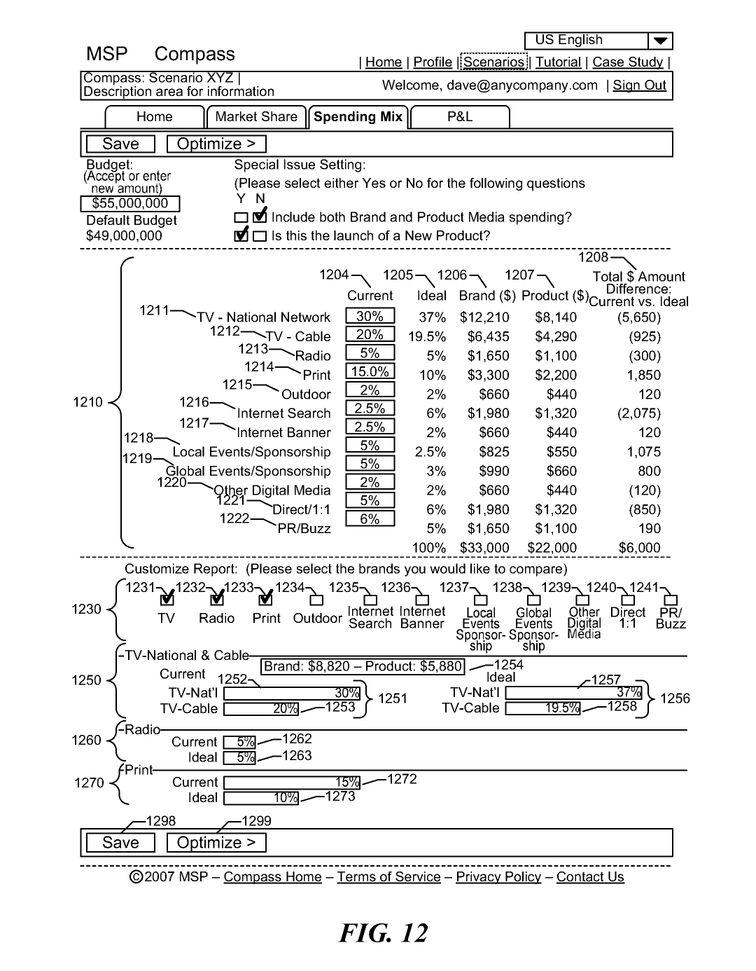

FIG. 12 is a display presented by the facility to show spending mix information. The display includes an overall budget 1201 prescribed by the facility. The user may edit this budget if desired to see the effect on distribution information shown below. The display also includes controls 1202 and 1203 that the user may use to identify special issues relating to the prescription of the marketing budget. The display further includes a table 1210 showing various information for each of a number of marketing activities. Each row 1211-1222 identifies a different marketing activity. Each row is further divided into the following columns: current percentage allocation 1204, ideal percentage allocation 1205, dollar allocation to brand in thousands 1206, dollar allocation to product in thousands 1207, and dollar difference in thousands between current and ideal. For example, from row 1214, it can be seen that the facility is prescribing a reduction in allocation for print advertising from 15% to 10%, $3.3 million of which would be spent on print advertising for the brand and $2.2 million of which would be spent on print advertising for the product, and that the current allocation to print marketing is $1.85 million greater than the ideal allocation. The display further includes a section 1230 that the user may use to customize a bar chart report to include or exclude any of the budget and marketing activities. It can be seen that the user has selected check boxes 1231-1233, causing sections 1250, 1260, and 1270 to be added to the report containing bar graphs for the TV, radio, and print marketing activities. In section 1250 for the TV marketing activity contains bar 1252 for the current percentage allocation to national TV, bar 1253 for the current percentage allocation to cable TV, bar 1257 for the ideal percentage allocation to national TV, and bar 1258 for the ideal percentage allocation for cable TV. The other report sections are similar.

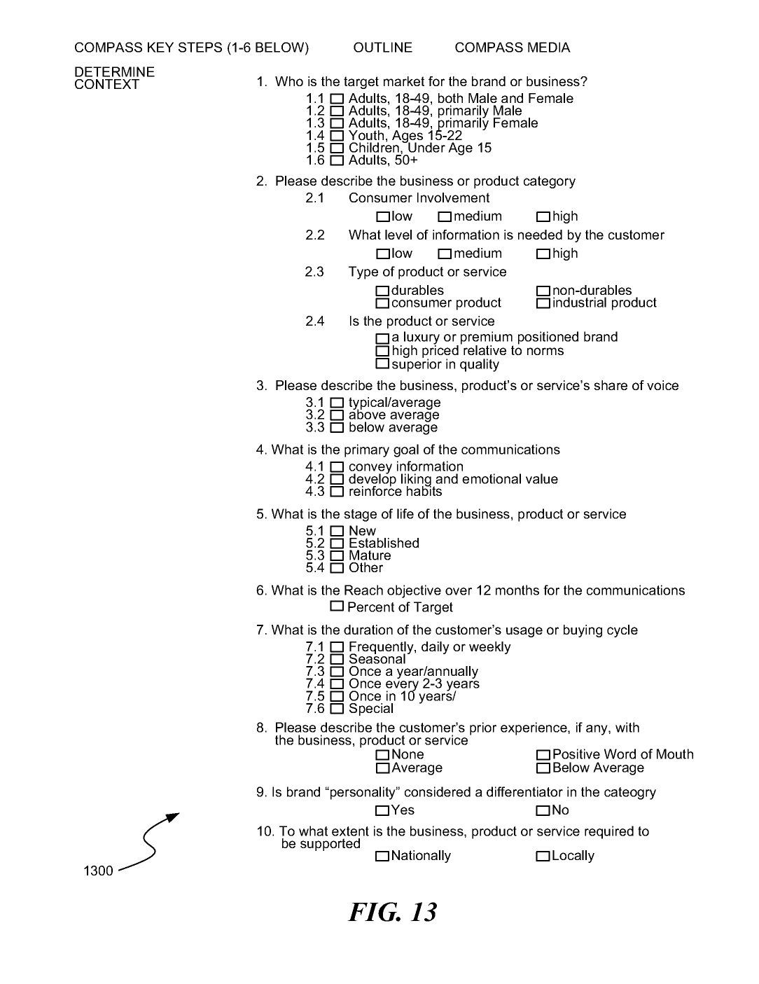

FIGS. 13-18 describe the process by which the facility determines the activity distribution shown in FIG. 12. FIG. 13 is a process diagram that describes collecting additional offering attribute information from the user. In some embodiments, this additional attribute information is obtained from the user using a user interface that is similar in design to that shown in FIGS. 6-9. FIG. 13 shows a number of attributes 1300 for which values are solicited from the user for the subject offering.

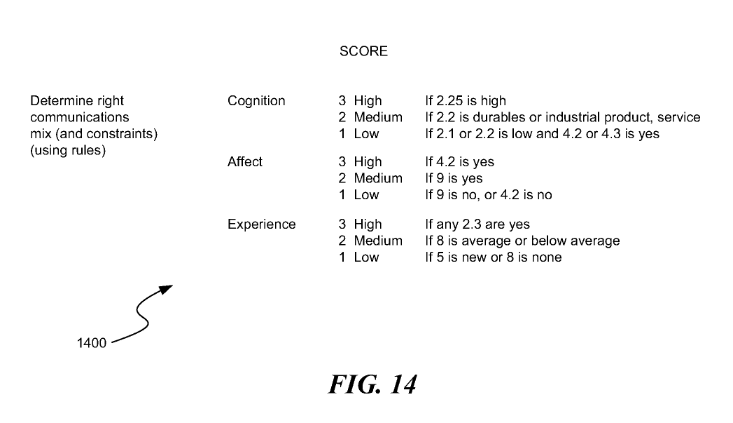

FIG. 14 is a process diagram showing the derivation of three derived measures for the subject offering: cognition, affect, and experience. The values for these derived measures are derived based upon the value of attributes shown in FIG. 13 provided by the user for the subject offering.

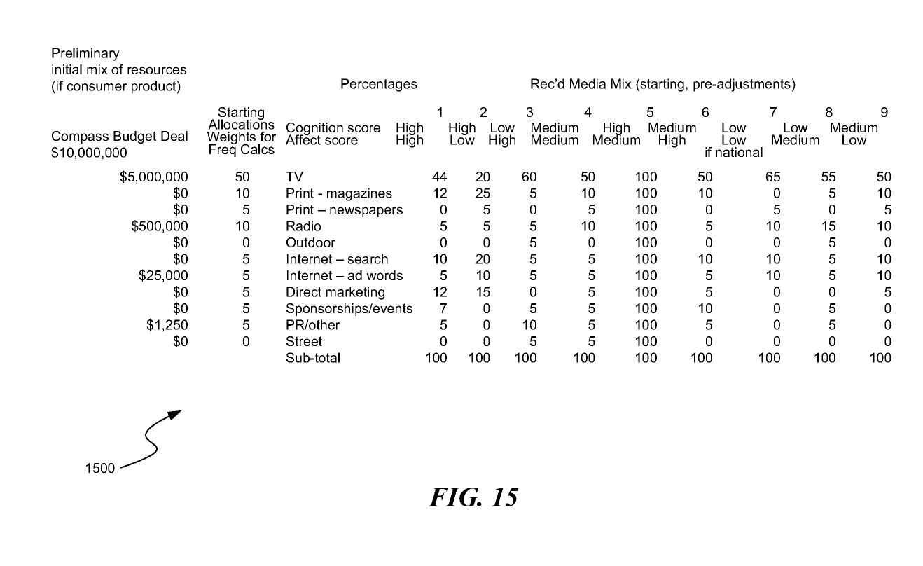

FIG. 15 is a table diagram showing sets of marketing activity allocations, each for a different combination of the three derived attributes shown in FIG. 14. For example, FIG. 15 indicates that, for subject offerings assigned a high cognition score and medium affects score should be assigned marketing resources in the following percentages: TV 44%, print magazines 12%, print newspapers 0%, radio 5%, outdoor 0%, internet search 10%, internet ad words 5%, direct marketing 12%, sponsorships/events 7%, PR/other 5%, and street 0%. Each of these nine groups of allocations is based on the relative activity elasticities, like those shown in FIG. 3, grouped by the cognition and affect scores indicated for the groups of historical marketing efforts contained in the library.

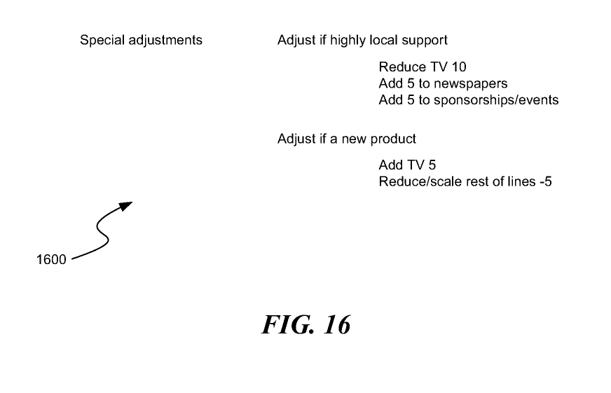

FIG. 16 is a process diagram showing how the initial allocation specified by the table in FIG. 15 should be adjusted for a number of special conditions 1600.

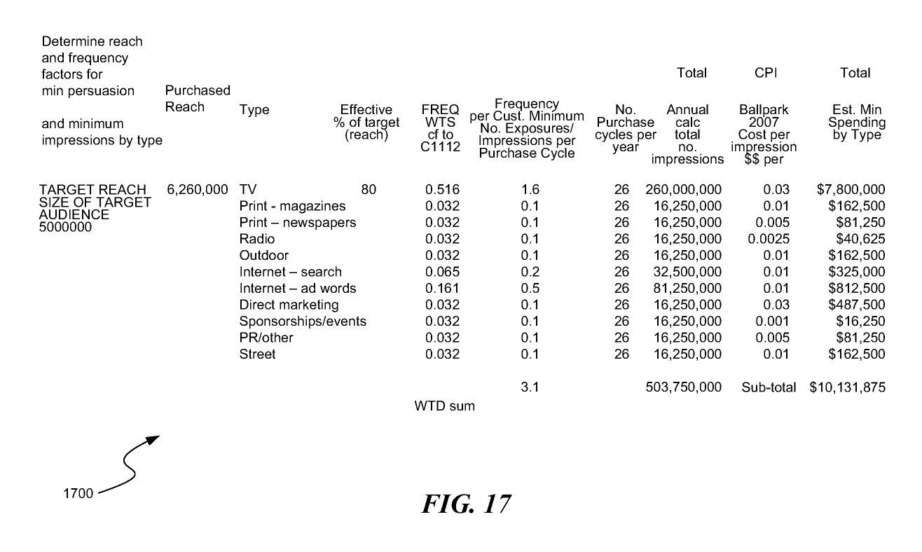

FIG. 17 is a process diagram showing how the facility determines dollar amount for spending on each marketing activity. The process 1700 takes the size of target audience specified by the user and divides by affective percentage of target to obtain a purchased reach—that is, the number of users to whom marketing messages will be presented. This number is multiplied by the adjusted allocation percentage to obtain a frequency per customer which is then multiplied by a number of purchase cycles per year and cost per impression to obtain estimated spending for each activity.

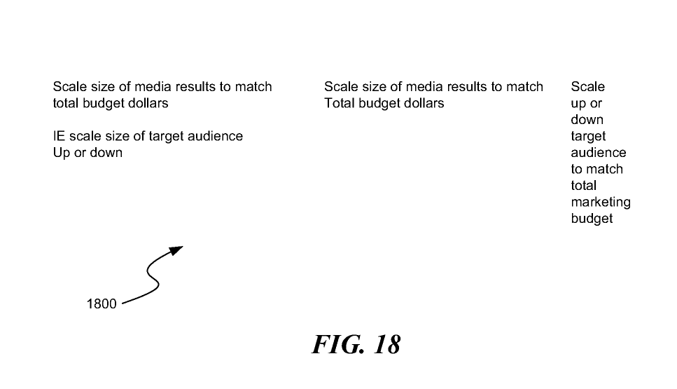

FIG. 18 is a process diagram showing the final adjustment to the results shown in FIG. 17. Process 1800 specifies scaling the target audience up or down to match the total marketing budget determined by the facility for the subject offering.

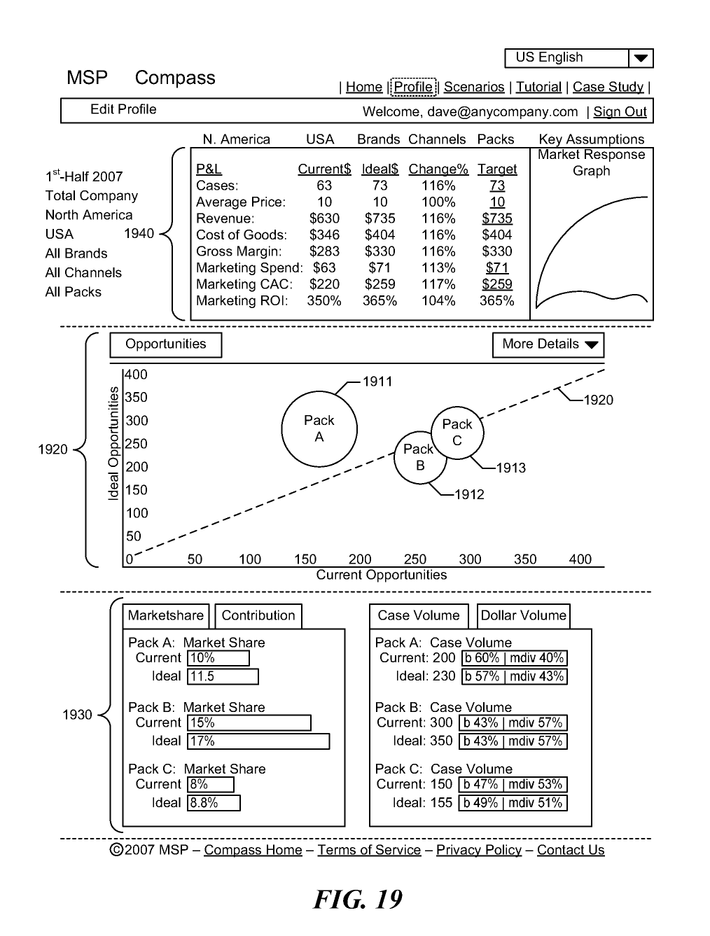

FIG. 19 is a display diagram showing a display presented by the facility to portray resource allocation prescriptions made by the facility with respect to a number of related subject offerings, such as the same product packaged in three different forms. The display includes a chart 1910 that graphically depicts each of the related subject offerings, pack A, pack B, and pack C, each with a circle. The position of the center of the circle indicates the current and ideal total marketing budget allocated to the offering, such that each circle's distance and direction from a 45° line 1920 indicates whether marketing spending should be increased or decreased for the offering and by how much. For example, the fact that the circle 1911 for pack A is above and to the left of the 45° line indicates that marketing spending should be increased for pack A. Further, the diameter and/or area of each circle reflects the total profit attributable to the corresponding subject offering assuming that the ideal total marketing budget specified by the facility for that offering is adopted. The display also includes a section 1930 containing a bar graph showing market share and volume, both current and ideal, for each related subject offering. The display also includes a section 1940 showing information similar to that shown in Section 1150 of FIG. 11.

In some embodiments, the facility considers data received from one or more of a number of types of external sources, including the following: syndicated media, syndicated sales data, internet media, internet behavioral data, natural search query data, paid search activity data, media data like television, radio, print, consumer behavioral data, tracking survey data, economic data, weather data, financial data like stock market, competitive marketing spend data, and online and offline sales data.

In various embodiments, the facility incorporates one or more of the following additional aspects, discussed in greater detail below:
1) Minimum Distance Matching of communication touchpoints to brand/client needs;
2) A classification method for communication needs (cognition, affect and experience);
3) The interactions of traditional media and internet media, as well as experience factors;
4) The joint optimization of core media, internet media and experience factors
5) The combination of user-specific multi-source data (USMSD) for outcomes and driver variables necessary for the computations;
6) The intelligent automation of the data stack for modeling;
7) The intelligent automation of model specifications, statistical estimation and expert knowledge;
8) The use of dynamic, real time internet “native” search data as predictive, momentum (DNM) indicators of marketing and brand response.
9) Measurement of the dynamic interactions, optimization, forecasting and prediction of outcomes using marketing drivers, brand momentum and marketing ROI
10) Reporting of brand/client results

### 1) Minimum Distance Matching

(1.1) Using the input questions for Information (Qx), Affect (Qy) and Experience (Qz), the facility classifies the brand/client communication needs using these 3 dimensions and a 3 point scale of low, medium and high (coded numerically as 1, 2, 3).

(1.2) The facility can allocate resources over any of a large number of communication touchpoints, also known as communication channels. For each channel, the facility considers the capability of the “medium” to deliver information, affect and experience dimensions of brand/client communications.

In selecting communication channels, the facility minimizes the “distance” between the communication needs and the mediums/channels to then select touchpoints that are relevant for market response and subsequent application of the elasticities and ideal economics computations.

Distance is defined as the sum of squared differences (SSD) between the brand/client need and the medium/channel.

Distance=(Medium Cognition−Brand Cognition)̂2+(Medium Affect−Brand Affect)̂2+(Medium Experience=Brand Experience)̂2 ̂ denotes exponentiation

### 2) Method of Classification

The method of classification is described in paragraphs 1.1 and 1.2 above.

### 3) The Method of Interaction Between Traditional Media and Internet Media

The core outcome equation is defined (elsewhere) as

Outcomes=(Base Outcome)*((Resource 1)̂Elasticity 1)*((Resource 2̂Elasticity 2) etc.

Additional resources multiply the right hand side.

The facility combines traditional media in Equation 3 as the so-called “direct path” linking resources and outcomes.

The facility extends this model to include the internet in 2 ways:
Method 3.1 is to add and include internet metrics for online display and paid search in conjunction with traditional media (TV, Print, Radio, etc.).
Method 3.2 is to also add and include one or more variables/metrics for internet “natural” search (VINS). An example of natural search is count data on words used in internet search boxes (as distinguished from impressions and clicks).

The facility then adds and applies a 2^{nd} “indirect path” equation whereby internet natural search is explained by traditional marketing and sales resources.

Marketing Outcome=F(traditional resources, internet resources, natural search, base)

Natural Search=F(traditional resources, internet resources, base)

These 2 equations work “recursively”.

Practically, marketing and sales resources drive consumer/market attention and discovery. The discovery behavior is measured by the natural search. Subsequently in the recursive process, internet resources then “convert” attention into action.

### 4) Joint Optimization

The direct and indirect path equations then provide the mechanics for the “topline” of the economics optimization.

The facility applies varying resource input levels, flows the outcomes through the recursive topline equations to yield outcomes and then applies the associated elasticities (for diminishing returns) and the associated margins and costs of resources.

Also, in some cases the facility extends this method with a 3^{rd} equation whereby Paid Search also is handled comparably to natural search. Hence, Paid Search is an intermediate outcome.

Any dynamic, momentum, intermediate or interim brand metric (awareness, consideration, buzz) is handled using this 3^{rd} equation method.

### 5) User-Specific Multi-Source Data (USMSD)

The demand/outcome equations require data inputs that are:
Brand specific;
External industry specific;
Data for Marketing and Sales resources; and
Internet specific data related to the brand/user/client

The facility is unique in bringing together these 4 data streams for the purposes of demand modeling using the 2 equation method outlined above.

5.1) Brand data typically includes volumetric sales, pricing, revenue, new customer counts, existing customer counts, customer retention, customer attrition and customer upsell/cross sell of products or services. It also includes industry and brand/client attributes from the input questions.

5.2) External data includes a series of external factors and drivers. Typically, these include elements describing economic conditions and trends as well as weather, competitors marketing and sales resources and others.

5.3) Marketing and Sales data includes various measures for resource inputs. These can include resource spending for communication mediums/touchpoints. They can include physical measures of resources for mediums/touchpoints (time-based, ratings points or physical units such as direct mail counts etc).

5.4) The Internet specific data includes mainly measures of natural search using word counts and counts of word clusters and semantic phrases. Typically, these word measures address the brand name itself, aspects of the key phrasing associated with the brand (the so-called universal selling proposition), aspects of the brand positioning such as Quality and more generic or generalized words associated with the brand.

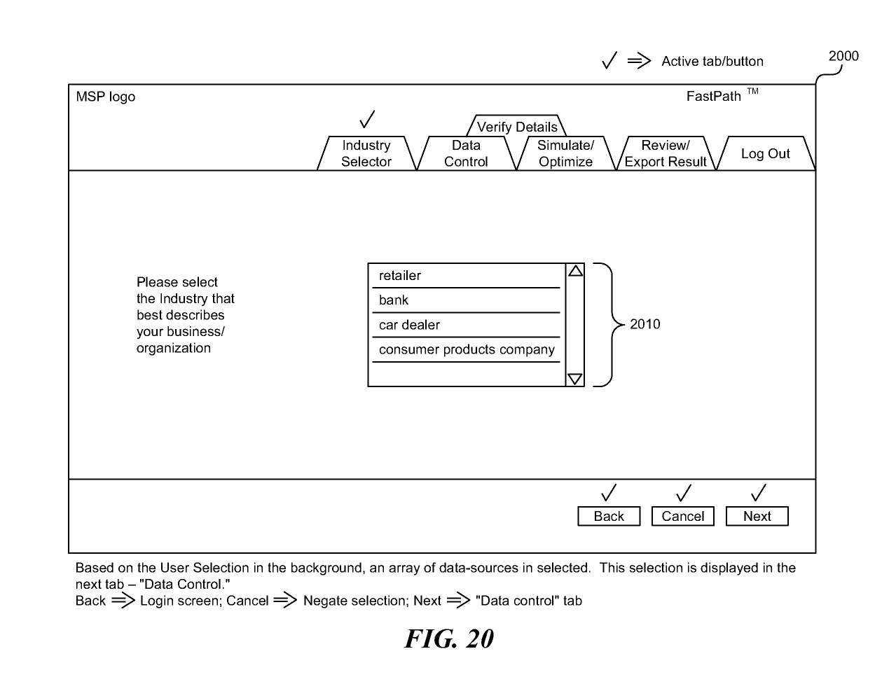

FIGS. 20-23 are display diagrams showing a typical user interface presented by the facility in some embodiments for specifying and automatically collecting some or all of these data inputs. FIG. 20 shows an initial display containing a list of business categories, from which the user selects the most appropriate category.

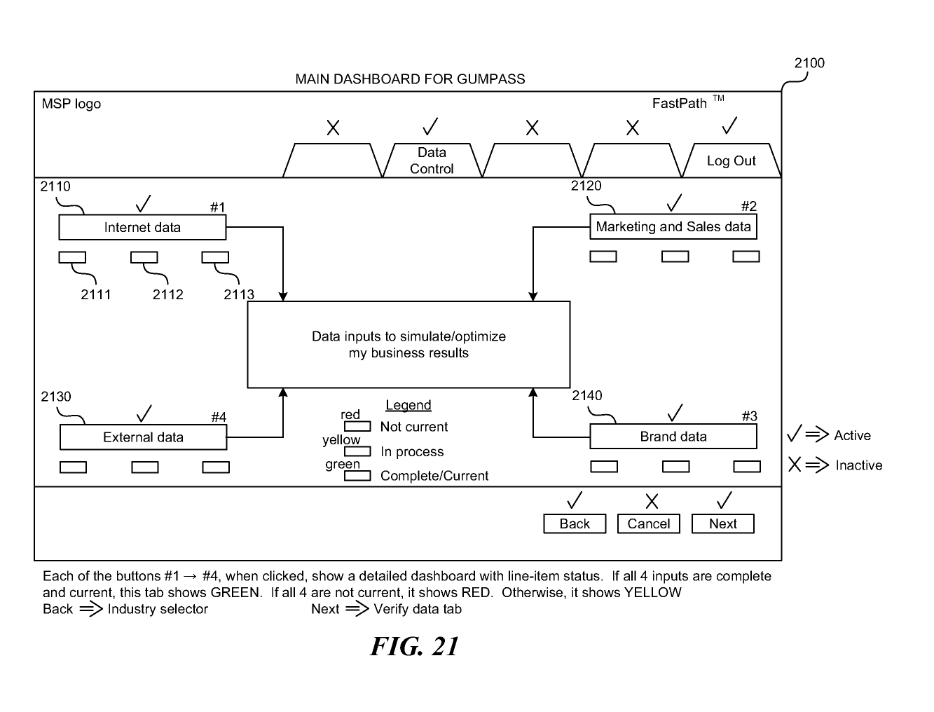

FIG. 21 shows a dashboard indicating the data retrieval status for the four categories of data inputs 2110, 2120, 2130, and 2140. Each type has status indicators—e.g., status indicators 2111-2113 for internet data category 2110—to indicate the retrieval status of data in this category. Additionally, the user can click on any of the data types to view detailed information about data of that type.

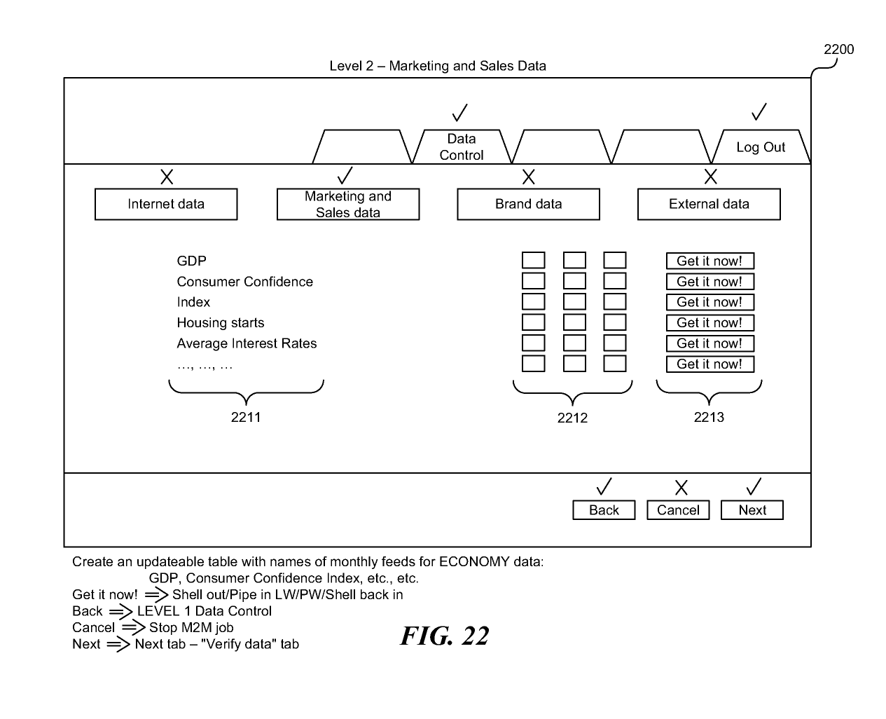

FIG. 22 shows a detailed display for data in the marketing and sales data category. This display 2200 shows a number of different components 2211 of the marketing and sales data category; status indicators 2212 indicating the retrieval status of each of the components, and controls 2213 that the user may operate to initiate retrieval of each component.

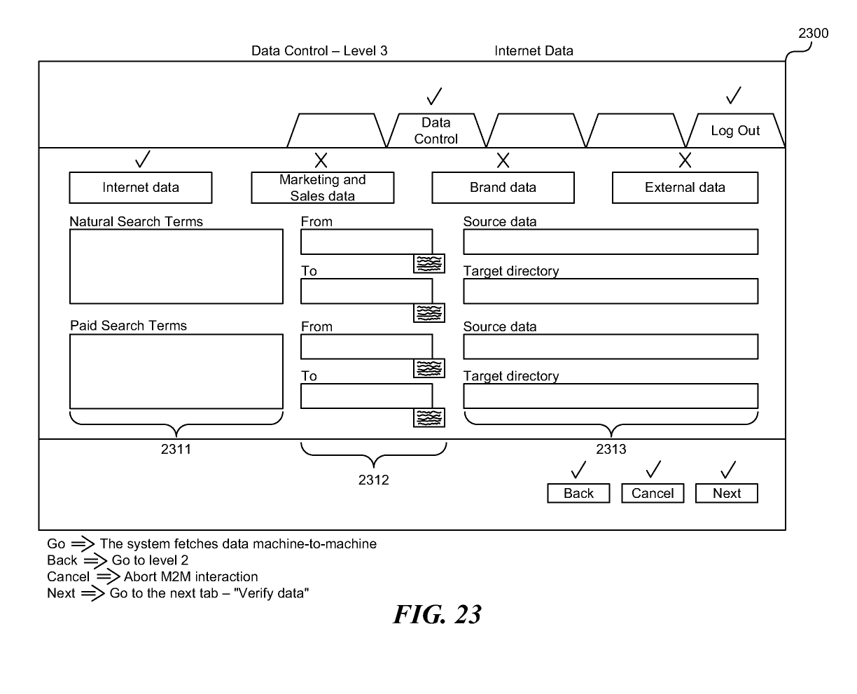

FIG. 23 shows a display. The display includes controls 2311 for entering natural search terms and paid search terms that are relevant to the offering; controls 2312 for specifying relevant time periods for each natural search and paid search; and controls 2313 for specifying where frequency data for a natural search and paid search is retrieved from and stored.

### 6) Intelligent Data Stack

The facility uses the data dashboard user interface shown in FIGS. 20-23 to allow users to select the appropriate set of outcome and driver data, as well as financial factors to be used by the facility.

The facility then provides a data input template for each data class (see 5.1, 5.2, 5.3, 5.4 above).

The facility then applies a set of quality and data scrubbing algorithms to verify for the user the overall completeness, consistency and accuracy of the designated data streams.

The facility then transforms and loads these data vectors into the overall the facility matrix for modeling (MOM).

The row structure for MOM typically involves time dimensions, customer segments, channels of trading and/or geographic layers.

The column structure for MOM typically involves final outcome variables, intermediate outcome variables and driver variables (see 5.1, 5.2, 5.3 and 5.4).

The facility uses a so-called log/log transformation for the data and the demand model specification.

Ln(Outcome)=Constant+Coef1*ln(Driver1)+Coef2*ln(Driver2)+Coef3*ln(Driver 3), etc.

The facility applies generalized least squares (GLS) methods for the statistical estimation of the various equations.

The facility also constructs any necessary “dummy” variables used in the econometrics, including seasonality.

### 7) Intelligent Estimation

The facility includes linkage and comparative methods across the Candidate Models (CM), the statistical diagnostics, t-values and GLS estimates of model/equation coefficients.

The facility conducts GLS estimation of approximately 40 CM variants and associated diagnostics. (The facility includes the numerical algorithms and methods for GLS.)

The facility then selects and utilizes the BLUS (best, linear, unbiased estimates) of response coefficients (response elasticities) for economic optimization for resource levels and mix.

This selection is determined by best fit, best t-values, the absence of multi-collinearity, the absence of serial correlation and elasticity estimates which are consistent with the Expert Library (CEL) and proper numerical signs (positive, negative).

### 8) Dynamic Native Momentum (DNM)

As described above, the word counts and word count clusters related and derived from internet natural search include and address concepts for brand momentum, brand quality and brand image.

The facility classifies these word/semantic concepts into driver variables which are relevant and used within the 2 equation direct path and indirect path equations (see above). These semantic “buckets” include counts of received queries, related to the brand name itself, counts related to the product or service category and the brand/clients competitors and counts related to more generalized themes (for example, hybrid technology vehicles vs. Lexus RXH).

The facility includes dynamic feeds of word counts from natural search from search providers such as Google, Yahoo or MSN or others (MySpaces, Facebook, YouTube) as well as wireless and mobile devices.

DNM data are typically a dynamic sample of on-going internet traffic. The facility uses counts per “x” million queries.

### 9) Dynamic Use of Internet Momentum in Optimization, Prediction and Forecasting

The facility uses the 2 equation method outlined above to construct top-down optimization of brand/client goals relative to resource drivers. Drivers here include both traditional marketing and sales, as well as pricing and internet resources.

The facility uses both direct computation (closed form calculus) and a branch and bound (B&B) heuristic method to compute ideal outcomes using the domain of resource drivers.

### 10) The Facility Reporting of Brand/Client Outcomes and Results

The facility includes visual reporting and GUIs for brand/client outcomes (see Compass SMB, Compass Agency and Compass USMSD/DNM herein.) For example, in various embodiments, the facility displays outcomes using one or more of a sales response curve, a profit curve, and a current vs. ideal bar graph.

In various embodiments, the facility allocates resources across some or all of these channels, and in some cases additional channels:

### Television

Movie theatre

### Radio

### Newspapers

### Magazines

Print articles
Customer magazines
Loose inserts
Internet advertising
Internet search
Brand/company websites

### Emails

### Outdoor

Home shopping TV
Product placement

### Airport

Public transportation
Sponsorship of sports events
Sponsorship of other events
Doctor's office
800/toll free lines
Mailings at home
Celebrity endorsement
In-store advertising
In-store examination
Promotions and special offers
Product samples
Recommendations from friends and family
Recommendations from professionals
Video on demand
Video games
Streaming video

### Interactive TV

Spec text table

### “Ace” Adjusted, Multi-Source Market Response Elasticity Library

Market response optimization (MRO) typically requires best, linear, unbiased estimates (BLUS) of resource response elasticity parameters which are based on data which embodies (1) adequate variation in resource levels and mix, as well as (2) adequate data observations.

In some embodiments, the facility uses a 4-step method for computing BLUS estimates of elasticity using cross-brand and cross-resource 3^{rd} Party data. The 4-step method uses of ACE-L meta-data in combination with consistent 3^{rd} Party data on outcomes and drivers in further combination with the best statistical methods for BLUS.

The value and result is a comprehensive database of cross-brand, cross media elasticities which is used for resource optimization. This overall methodology allows and measures (1) the pure effect of resource spending on sales outcomes across a wide range of cross brand and cross resource conditions and (2) the impacts of alternative ways to define “content impacts” via the ACE-L scores

Multi-Source Data

There are 2 main classes of data for modeling—outcomes and drivers. For econometric modeling, the ACE method typically utilizes combined time-series and cross-section data.

For the Multi-Source Library (MSL) and outcomes (dependent variables), ACE uses a consistent definition of sales revenue for the brands/services in the library.

For the Multi-Source Library (MSL) and resource drivers, ACE uses a range of independent variables.

Step 1: The facility obtains data for these drivers from 3^{rd} Party data providers. For example, data series on media spending by time period, market location and type of media can be obtained from 1 or more 3^{rd} Party sources. Data classes include the economy, competition, tracking, pricing, channel funds, salesforce, retail store conditions, offline marketing and online marketing as well as certain momentum data.

Typically, these 3^{rd} Party data sources (3PDS) have known or well understood differences relative to client-specific transactional data (errors in variables, see below). However, these differences are generally thought to be consistent.

The cross-sections in the Multi-Source Library consist of brands/services, geographies and more. We apply the 3PDS resource drivers, defined consistently, within and across the library data for the brands, etc. Effectively, the facility eliminates data variation due to differences in data definitions across brands/clients.

ACE Adjusted, Dynamic Parameters

the basic method is to define Sales=Base Volume times (Marketing Resource) ̂ Elasticity Parameter, where ̂ denotes the natural exponent.

Sales=(Base)*(Resource)̂ (Delta)

For each brand (i.e. data record), the facility defines its ACE scores on a 1-5 scale—for Affect (A), Cognition (C) and Experience (E). Also, the facility adds one factor for Local Market or Time Sensitivity (L).

Step 2: The facility then extends the modeling using the following specification:

Elasticity Parameter (Delta)=(c0+c1*Affect+c2*Cognition+c3*Experience+c4*Local).

Each record (cross-section) in the Library uses and includes the ACE-L scores.

Practically, what this means is that up and down movement in the elasticity due to the brand characteristics, and the capacity of the media type to carry the content related to affect, cognition, and experience, is permitted.

For example, increasing the Affect score needed to motivate the consumer in turn will allow the elasticity of TV media to increase in this situation versus other brands with differing content goals. Lift factors for Print and Internet increase with information needs. Lift for Outdoor, Radio and Newspaper increase with the local market focus.

Complete BLUS Estimation of Response Elasticities

The basic or core elasticity parameters, absent ACE-L, use a formulation as follows:

### Core Equation:

Ln(Sales)=d1*Ln(Sales Prior Period)+d2*Ln(Base)+Delta*Ln(Resource)+Other+Error

Each resource extends this formulation similarly. Other factors which drive “Delta” are described in Compass®, including innovation.

Step 3: The facility substitutes forward the ACE adjustments into this Core Equation to replace Delta. The result are a series of direct effects and “interactions” with the ACE components, as additional drivers. As an example:

Partial Component of Core Eq=(C0*Ln(Resource)+C1*Affect*Ln(Resource) etc. etc.)

Proper estimation of these direct and interaction parameters requires that the data and formulation are consistent with certain rules.

One rule or assumption is that the error terms are independent and identically distributed (iid), albeit with similar variances.

However, due to the cross-section design, several aspects of the homogeneity assumptions will not be met.

This condition is known as heteroskedasticity.

Step 4: To correct for heteroskedasticity, the facility applies both Generalized Least Squares (GLS) estimation using Fixed Effects and corresponding “weights” for the cross-sections.

Other rules include correcting for serial correlation using lag terms.

### Optimally Allocating Resources to Sales Activities

In some embodiments, the facility specifically determines an optimal allocation of resources to direct sales alternatives.

Sales=multiplicative function of:
number of sales calls (to prospects and customers)
level of sales support (samples, demo material, etc)
MDF
trade shows/events
advertising

All resource allocation inputs are typically in dollars. Accordingly, if preferred input is “number of sales calls”, the facility asks “average cost per call” as well, and multiply the two to arrive at a total dollar investment.

The model architecture used for allocating resources to sales activity is similar to that discussed above. Likewise, calculations for revenue, profit, base levels, goal setting, etc. follow the same principles as discussed above.

In some embodiments, the facility solicits current spending levels for all buckets. If a bucket is not applicable (e.g. there is no MDF in the business), then the user should indicate so, and the facility omits the bucket from the analysis. Likewise, if sales support is indistinguishable from sales calls, then the facility combines the two under “sales calls”.

Optimal allocation follows the Dorfman-Steiner principle, in which allocation is proportional to relative lift. In some embodiments, the facility permits user-driven constraints to be imposed (e.g. no fewer than $2 million in sales calls, no greater than 30% change in any allocation, etc. . . . ), which may cause deviations from theoretical optimality.

### Questions

The facility asks general firmographic questions, as well as sales-specific questions as discussed in greater detail below. These include:
What is the life-cycle stage of the products being sold? Scale from all new to all mature?
North America vs. other markets?
Organizational buyer vs. individual buyer? Scale from all-org to all-individual?
What is the planning period considered (e.g., quarterly or annual)?
Are your sales gains typically at the expense of competitors? Scale from “yes, totally zero-sum business” to “no, gains are purely market expansive.”
What percent of calls to existing vs. new customers?

### Elasticities

The facility uses the answers to questions like the foregoing to determine adjusted elasticities for factors like the factors listed above: cost of sales calls, level of sales support, MDF, trade shows/events, and advertising. In some embodiments, the facility uses an elasticity for level of sales support near 0.05; an elasticity for MDF around 0.3; an elasticity for trade shows/events near 0.03; an elasticity for advertising near 0.05 for new products and near 0.02 for existing products; and develops an elasticity for a cost of sales calls based upon factors such as a constant sales call elasticity level; offering life cycle; market country; whether the product is new; whether the sales are institutional; and a sales output measure.

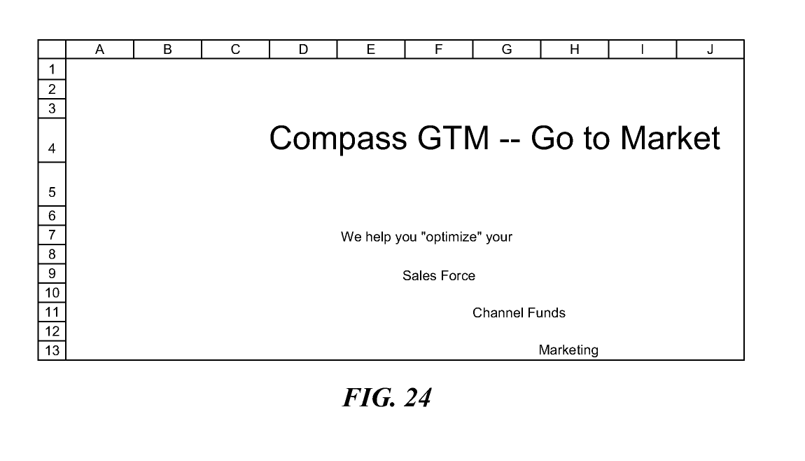

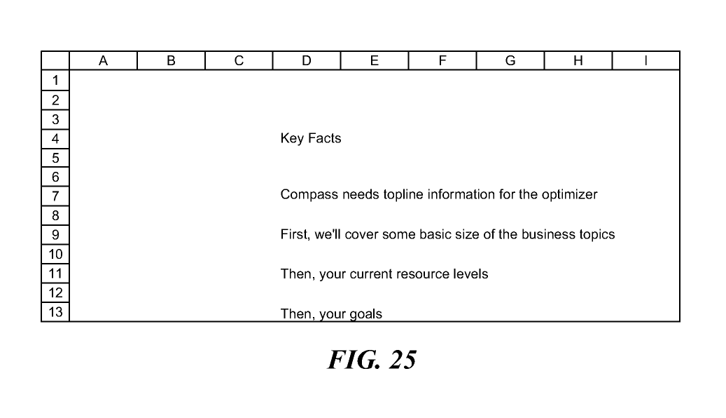

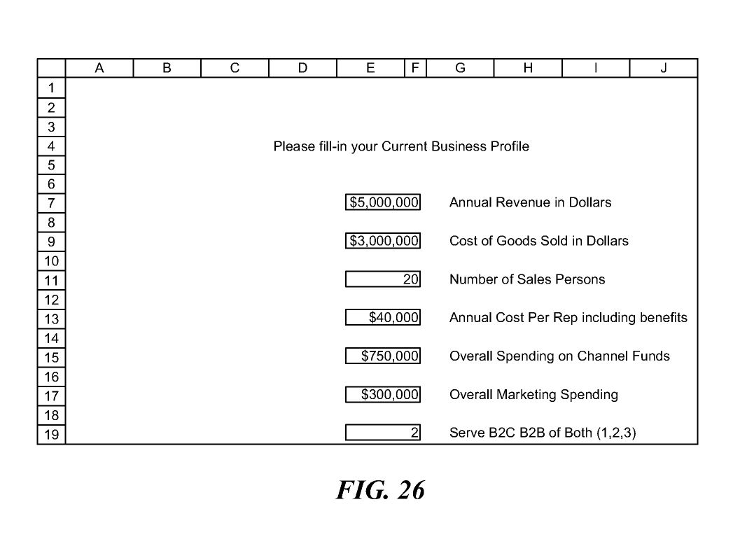

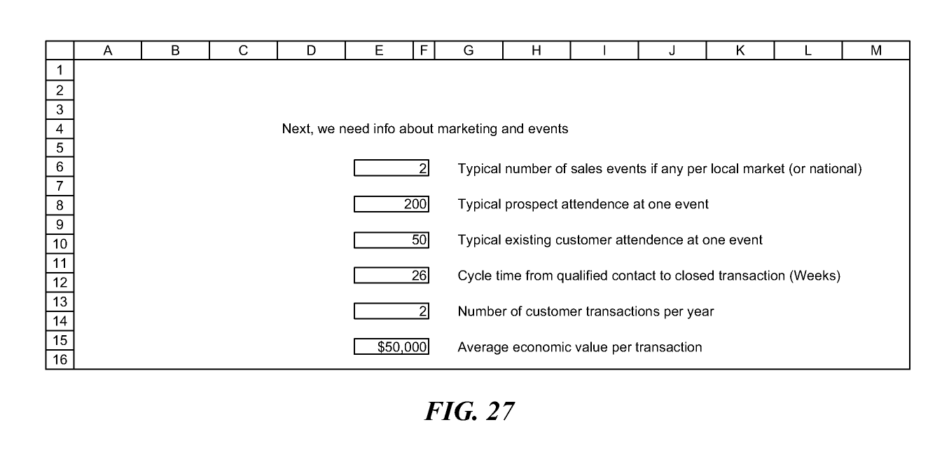

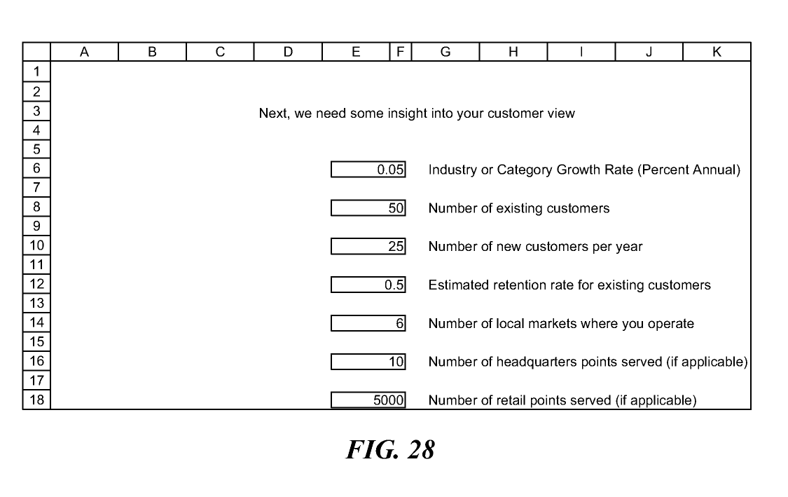

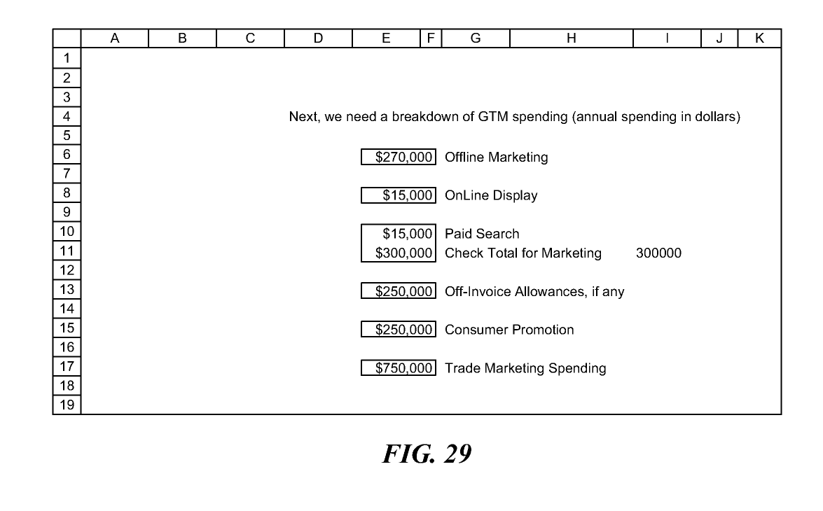

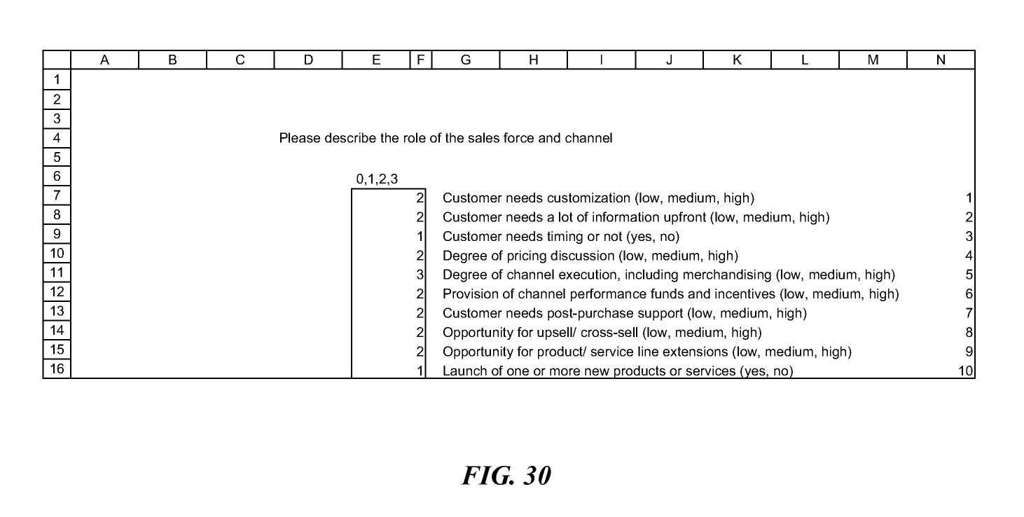

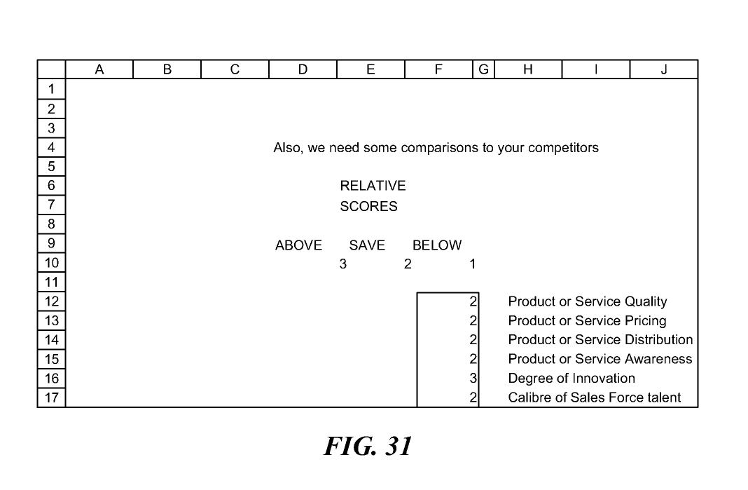

FIGS. 24-36B illustrate a first approach to optimizing the allocation of resources to sales activities used by the facility in some embodiments. FIG. 24 shows goals communicated by the facility in some embodiments. FIG. 25 shows categories of information collected by the facility in some embodiments. FIG. 26 shows information about the client solicited from the user that relates to the client's current business profile. FIG. 27 shows information about the client solicited from the user that relates to typical sales processes. FIG. 28 shows information about the client solicited from the user that relates to customer profile. FIG. 29 shows information about the client solicited from the user that relates to current allocations of typically marketing activities. FIG. 30 shows information about the client solicited from the user that relates to experiences that the sales force had had with customers. FIG. 31 shows information about the client solicited from the user that relates to the strength of the client's assets relative to those of competitors.

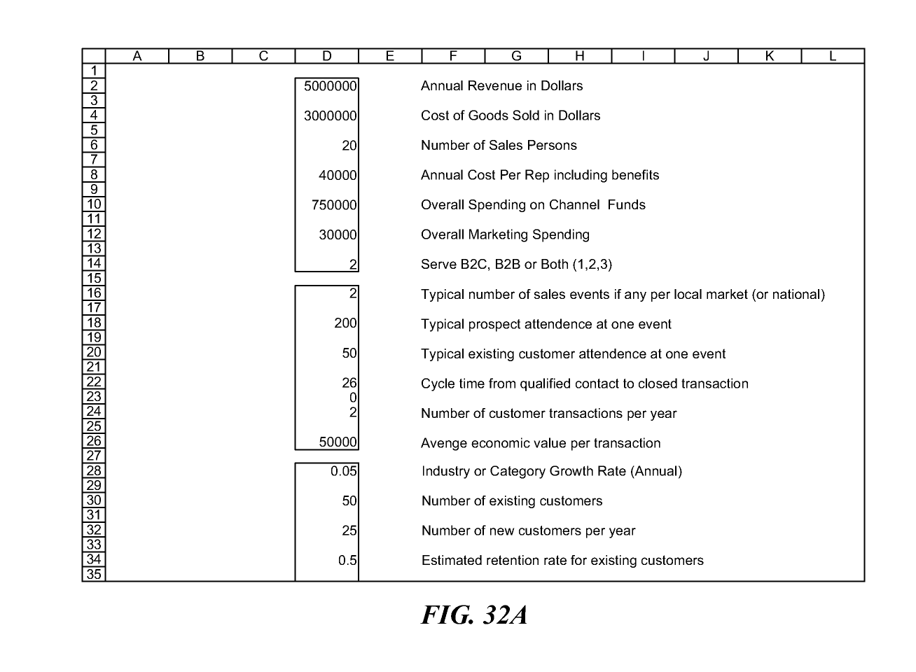

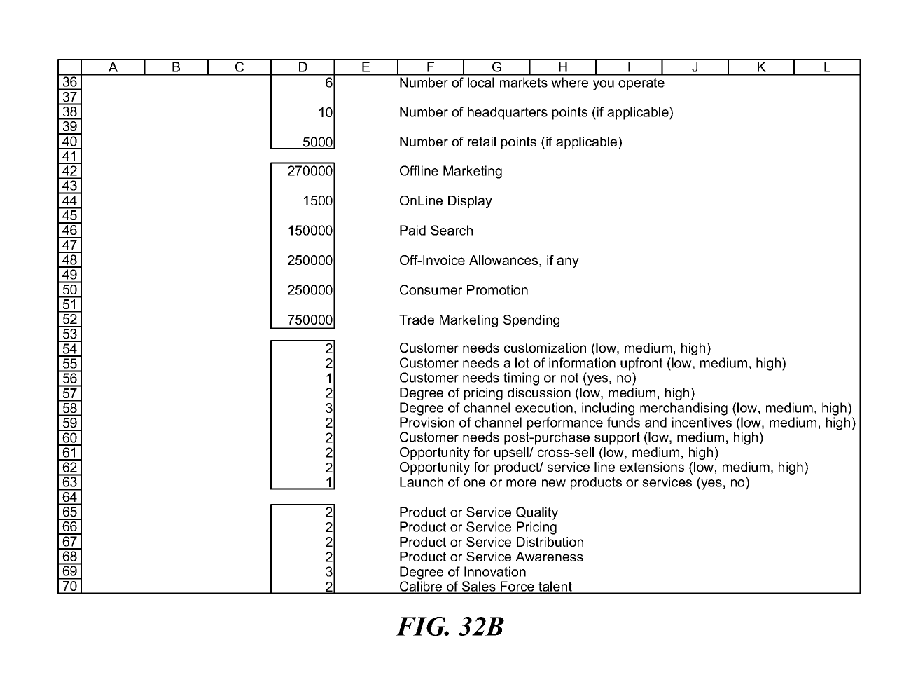

FIG. 32 shows all of the client data collected in connection with FIGS. 26-31.

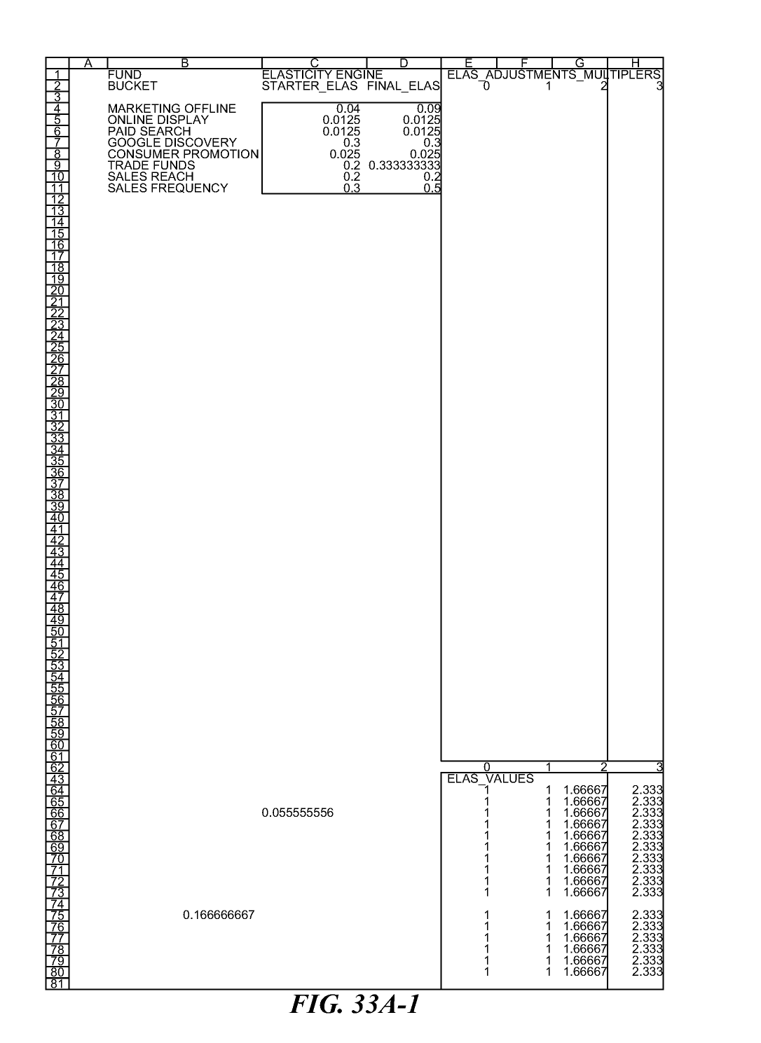

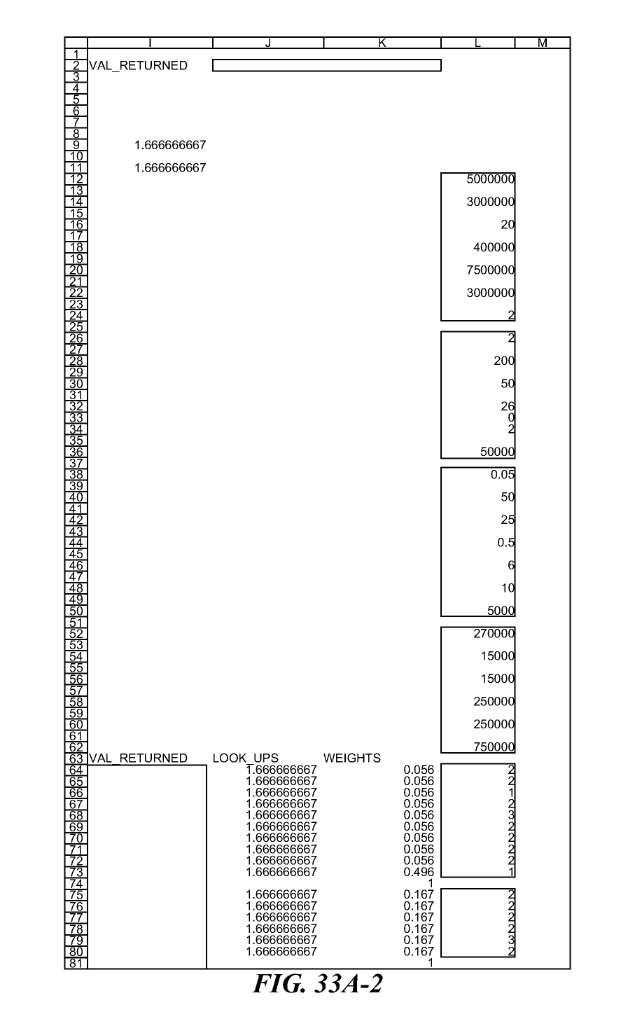

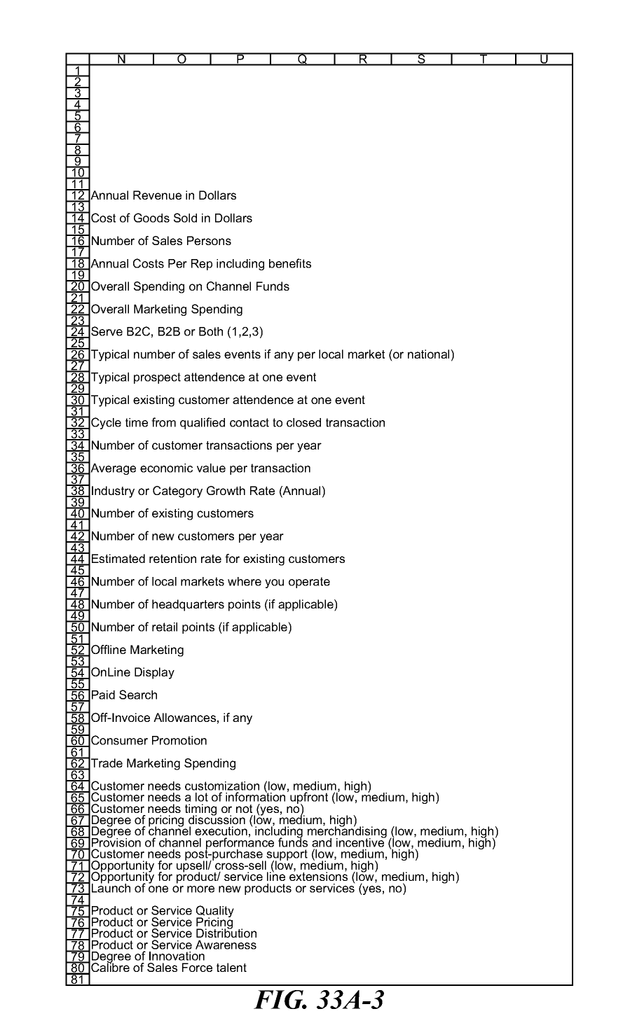

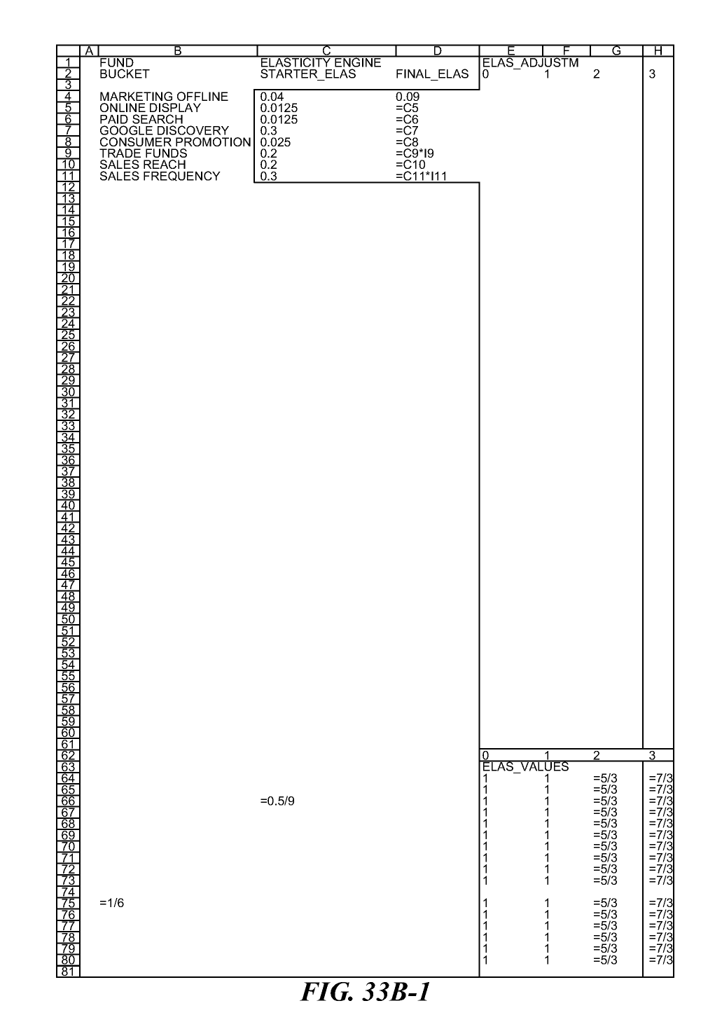

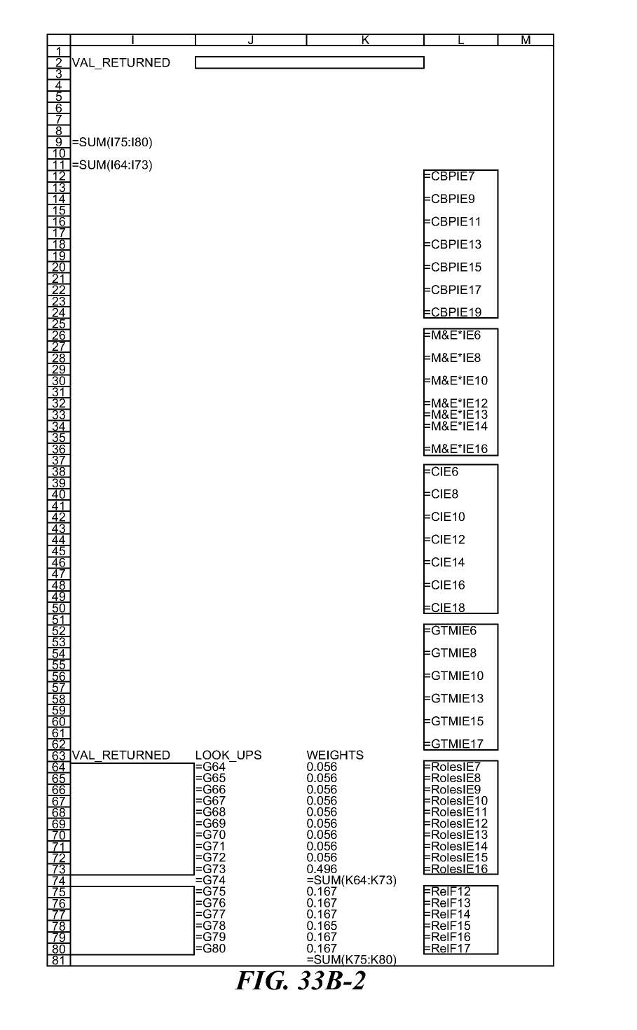

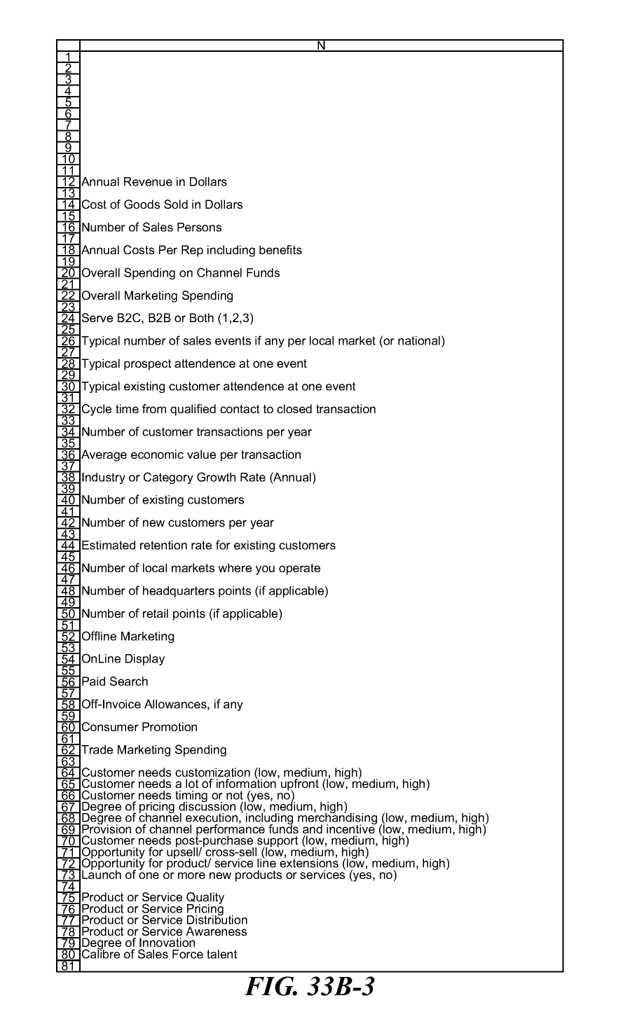

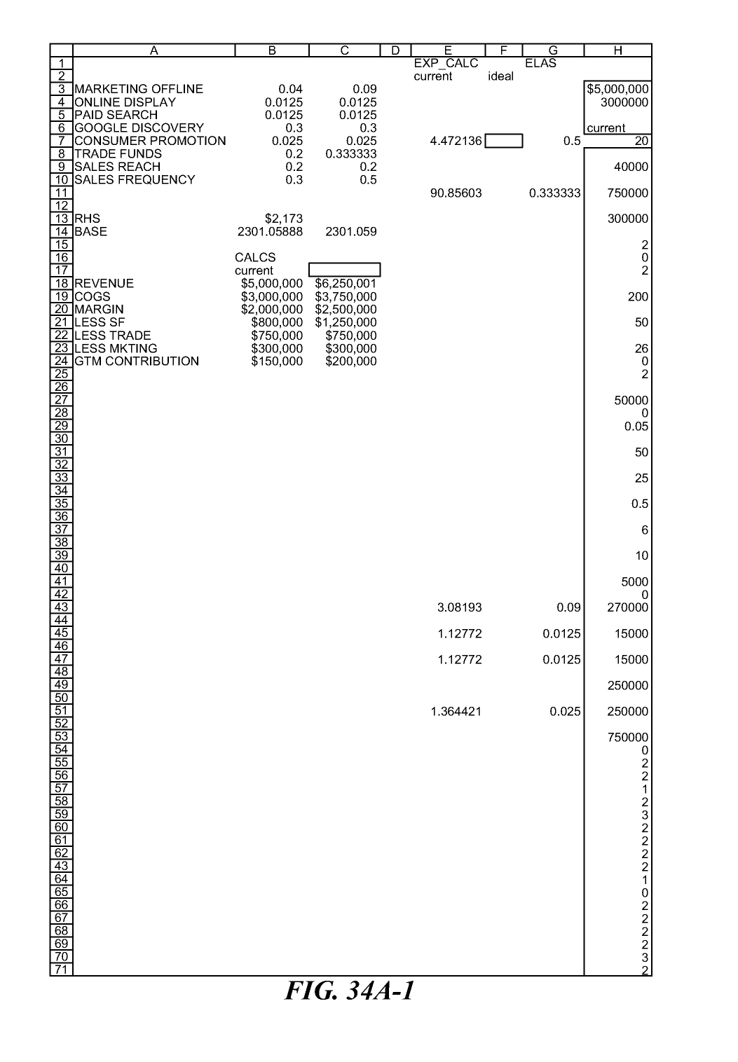

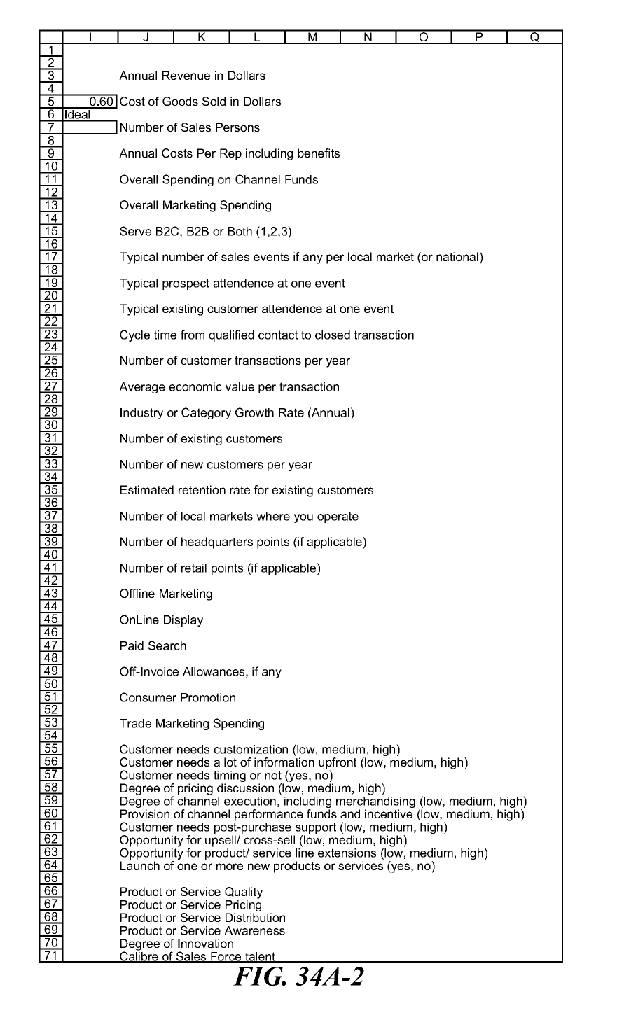

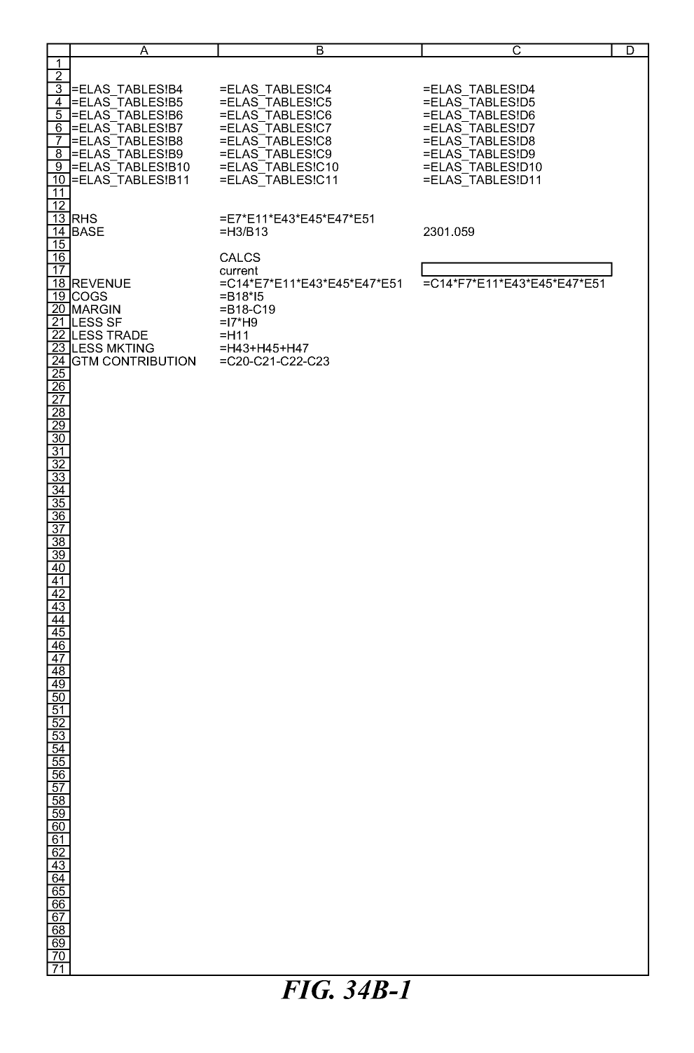

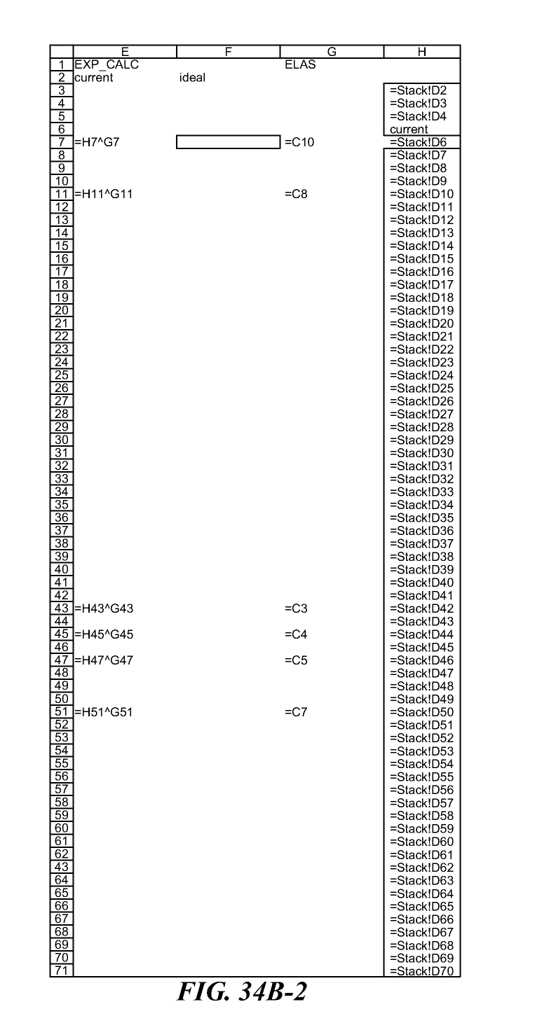

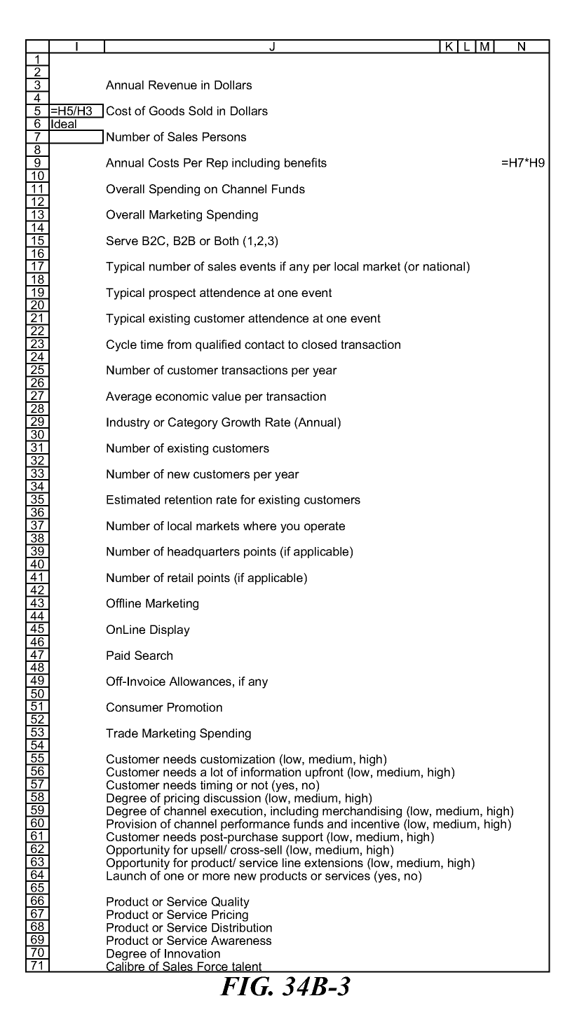

FIGS. 33A and 33B show the adjustment of certain elasticity measures in response to the inputted client information. In a manner similar to FIGS. 34A and 34B, 35A and 35B, 36A and 36B, 44A and 44B, and 45A and 45B discussed below, FIGS. 33A and 33B are two different views of the same spreadsheet table; FIG. 33A shows the value for each cell in the table, while FIG. 33B shows the formula for each cell in the table. Cells D4-D11 in FIGS. 33A and 33B contain a number of “final” elasticity measures employed by the facility. These elasticity measures that are employed by the facility are based on a corresponding set of “starting” elasticities in cells C4-C11. The “trade funds” elasticity measure in row 9 and the “sales frequency” elasticity measure in row 11 are manipulated in accordance with the information inputted by the user before being used. In particular, the adjustment to the trade funds elasticity measure is made in response to the client information regarding competitive strength inputted by the user in FIG. 31 and shown in cells L76-L80. Similarly, the sales frequency elasticity measure is adjusted in connection with the inputted client information about experiences that the client's sales force has had with its customer base inputted in FIG. 30 and appearing in cells L64-L73. In the case of each of these questions, a weight for the question in column K is multiplied by a value in column J selected from the scalar factors in columns E-H to produce a value in column I. These values are summed in cells I9 and I11, respectively, and the respective sums are multiplied by the trade funds and sales frequency starting elasticities in cells C9 and C11 to obtain their final elasticities in cells D9 and D11.

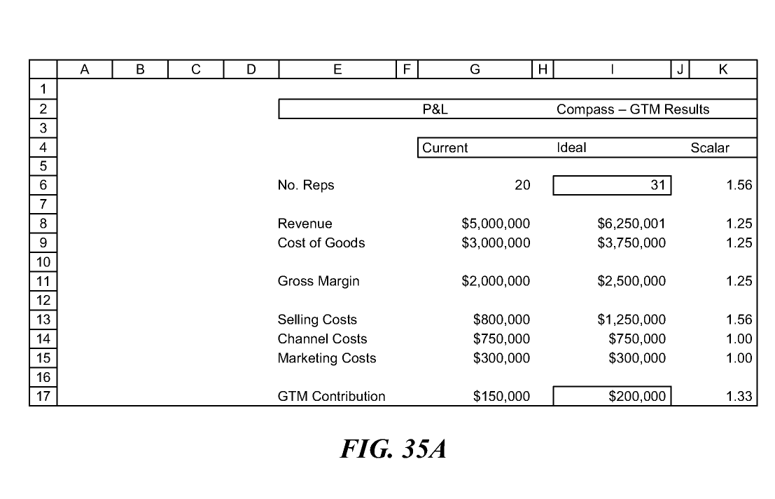

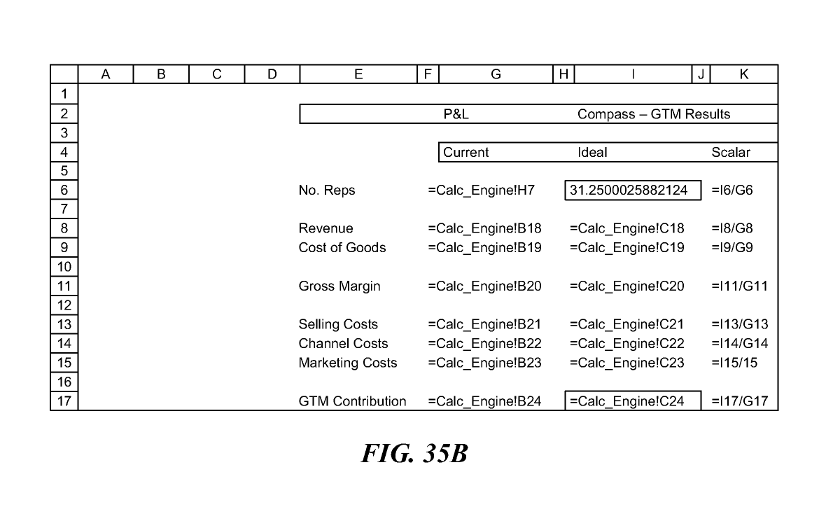

FIGS. 34A and 34B show the process by which the allocation of resources to sales activities is optimized. Cells B18-B24 show the current values of the following measures: revenue, cost of goods sold, margin (extent to which revenue exceeds cost of goods sold), sales force budget, trade budget, marketing budget, and go to market contribution, or profit (margin, less sales force, trade, and marketing budgets). Cells C18-C24 show the results when trade and marketing budgets are held constant, and sales force budget is permitted to vary as a basis for maximizing profit. In reviewing these cells, it can be seen that profit is increased by 33%, from $150,000 to $200,000, by increasing the sales force budget from $800,000 to $1,250,000. This increase in sales force budget is also reflected in cells H7-I7, which show an increase in the number of salespersons from 20 to 31.25. The current and ideal revenue numbers are based upon the number of salespersons value in cell I7, which is copied from cell I6 in the spreadsheet shown in FIGS. 35A and 35B, where that value is calculated.

FIGS. 35A-35B show additional details about the optimization. In particular, the number of salespeople or sales representatives shown in cell I6 is obtained by solving the value of that cell in order to maximize the value of cell I17 total GTM contribution, or profit.

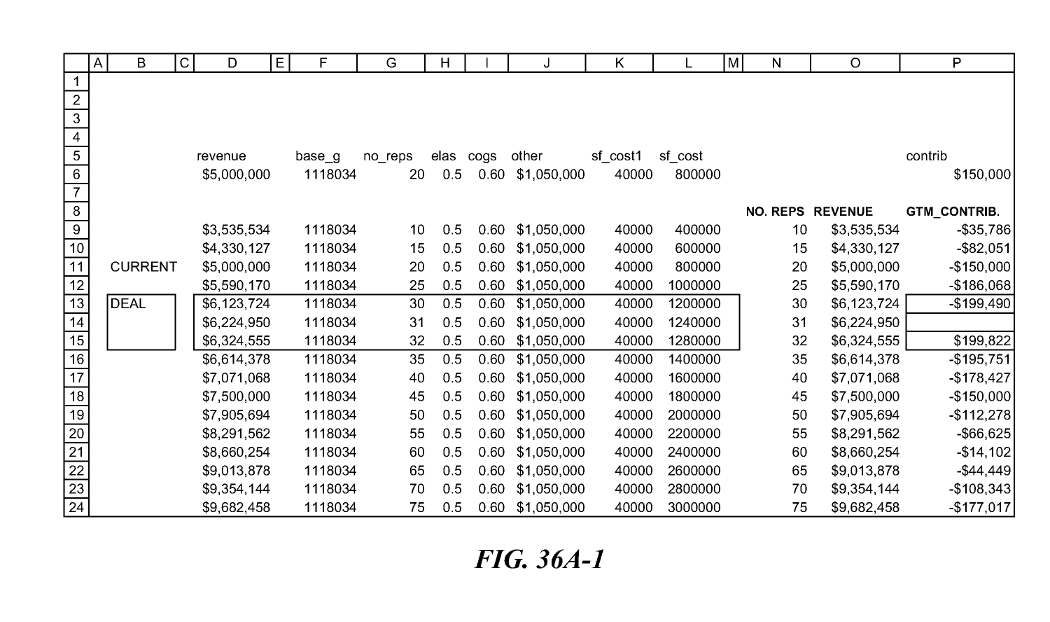

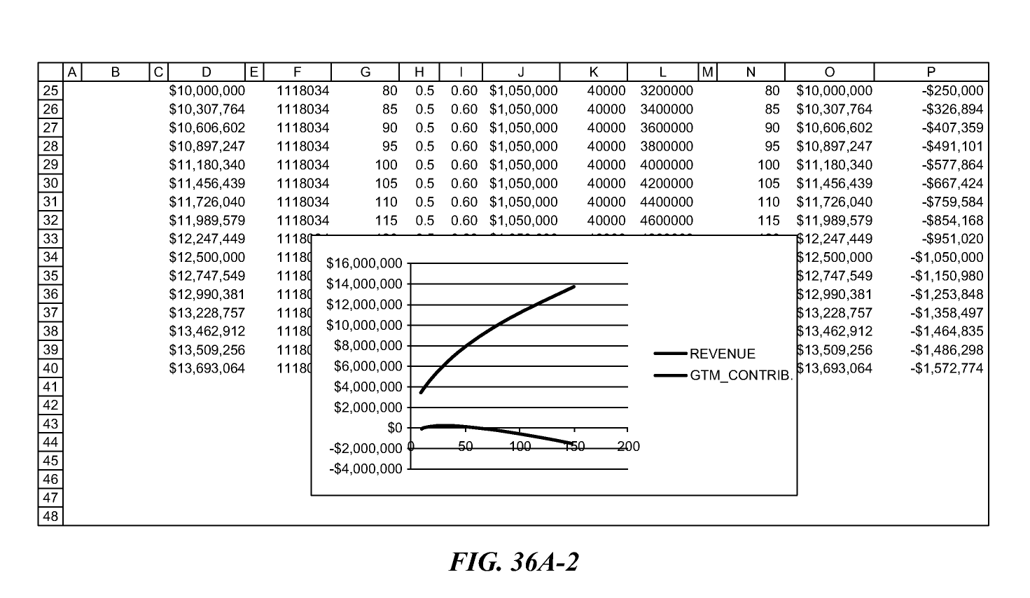

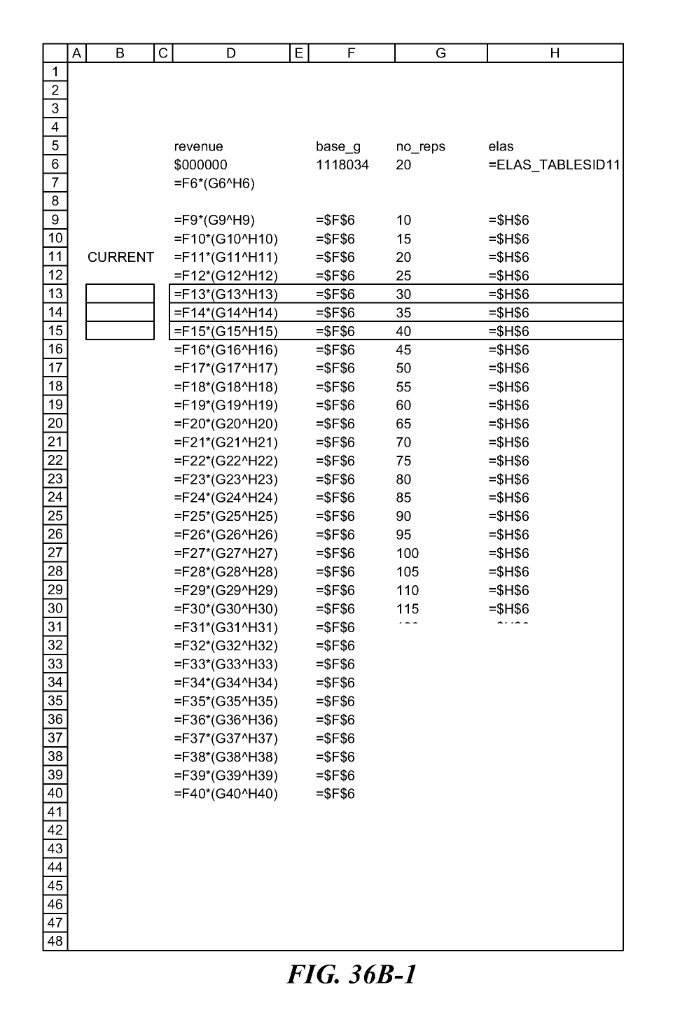

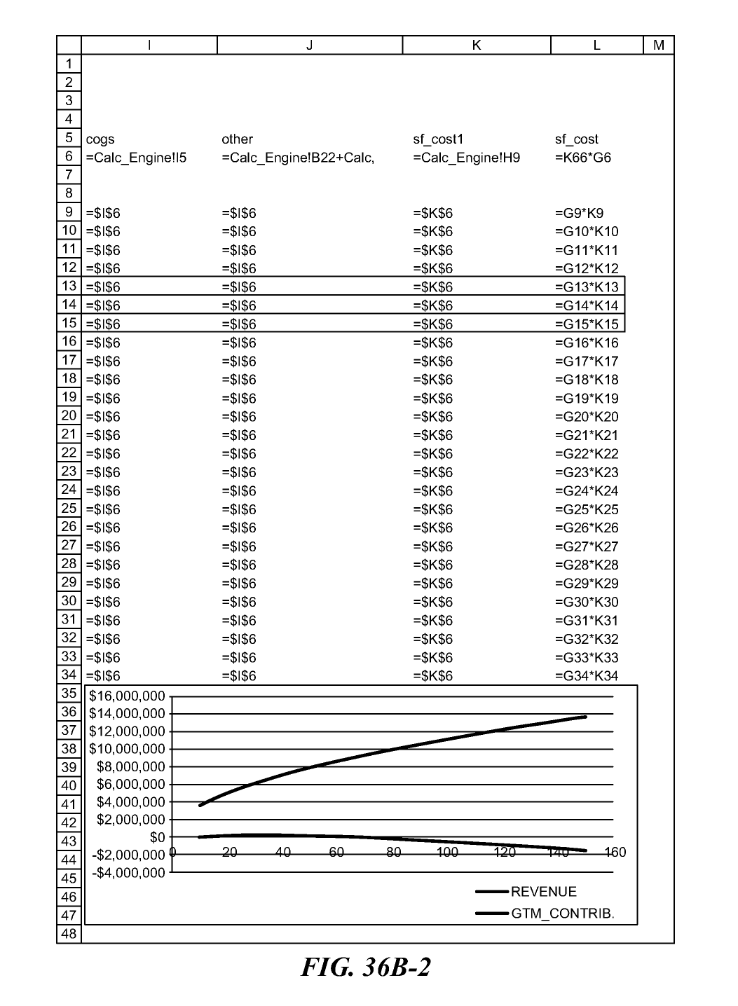

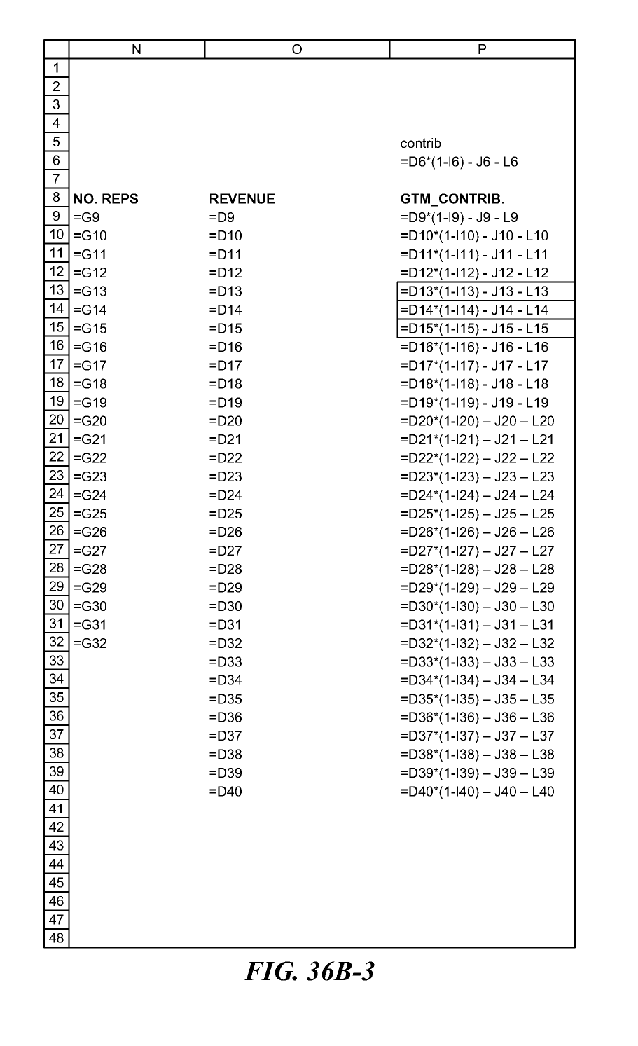

FIGS. 36-36B show an exhaustive elaboration of revenue and profit in columns O and P for different alternative numbers of representatives in column N. It can be seen that the current allocation of 20 representatives shown in row 11 produces a lower profit than the optimized number of representatives, 31, shown in row 14, as well as neighbors shown in rows 13 and 15 that produced very similar profit levels. Also, a graph shows that revenue continues to rise as number of representatives increases, but profit increases up to 31 representatives, than declines as additional representatives are added.

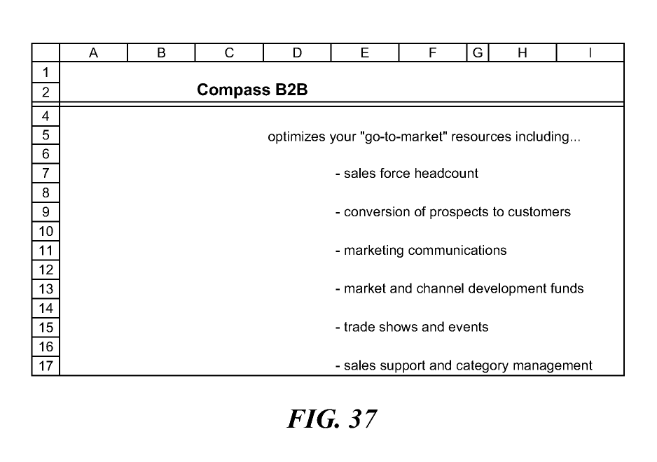

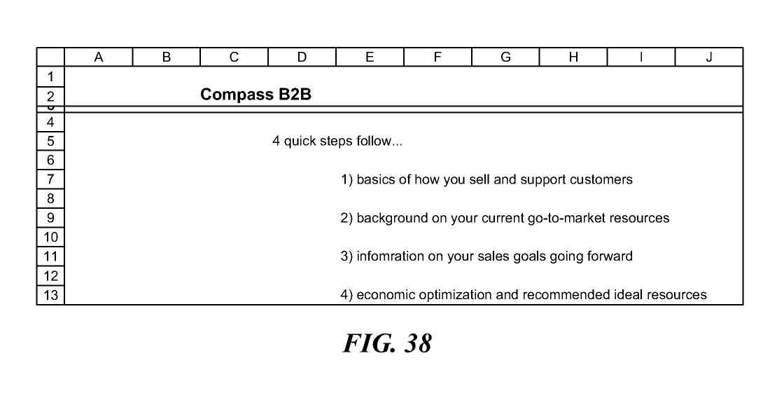

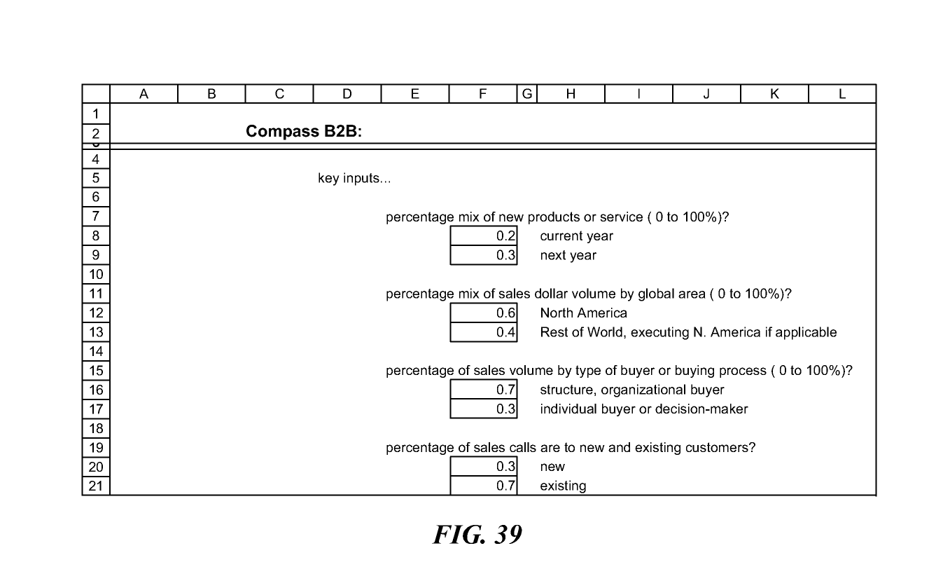

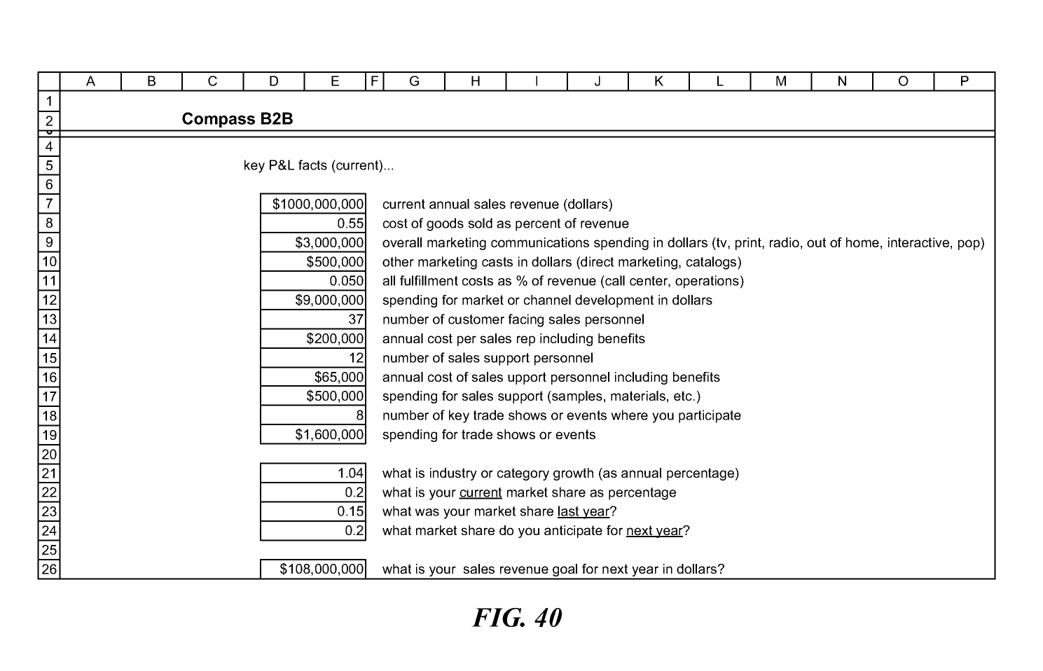

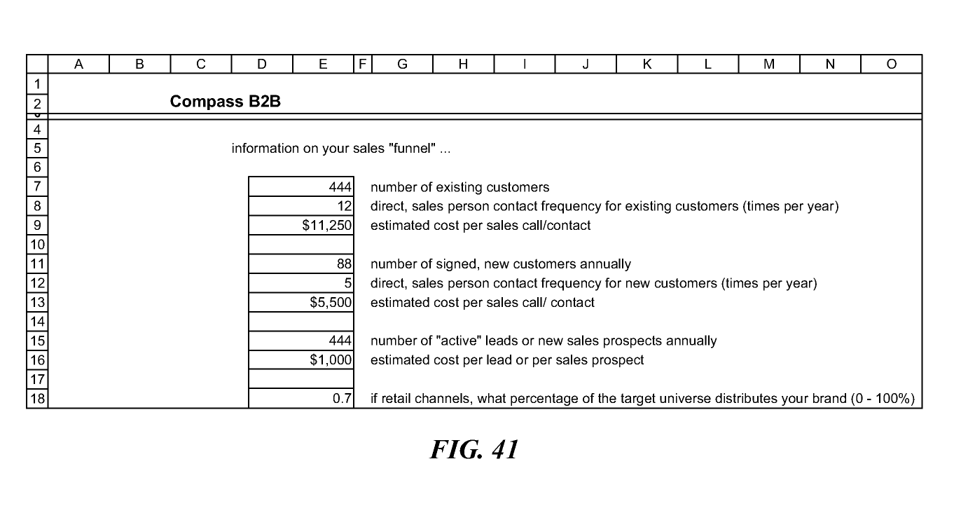

FIGS. 37-45B illustrate a second approach to optimizing the allocation of resources to sales activities used by the facility in some embodiments. FIG. 37 shows goals communicated by the facility in some embodiments. FIG. 38 shows categories of information collected by the facility in some embodiments. FIG. 39 shows information about the client solicited from the user regarding product offerings and sales efforts. FIG. 40 shows information about the client solicited from the user regarding the client's profit and loss facts. FIG. 41 shows information about the client solicited from the user that relates to the client's “sales funnel,” or aggregated sales status statistics.

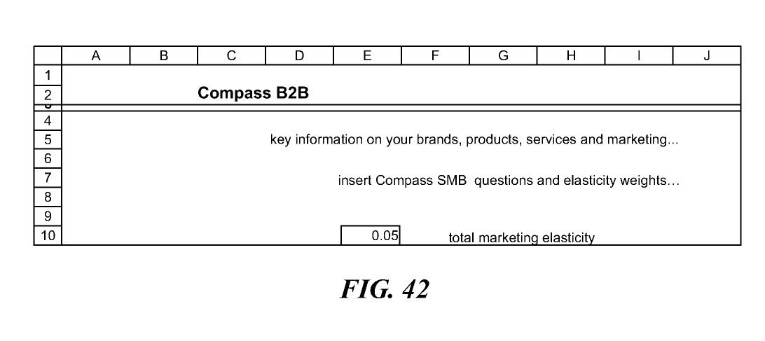

FIG. 42 shows a measure of the client's total marketing elasticity to be used by the facility.

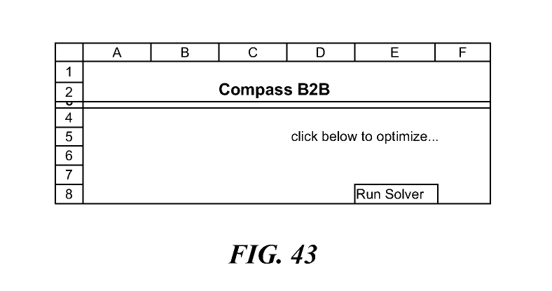

FIG. 43 shows a control that the user may activate in order to trigger the optimization process.

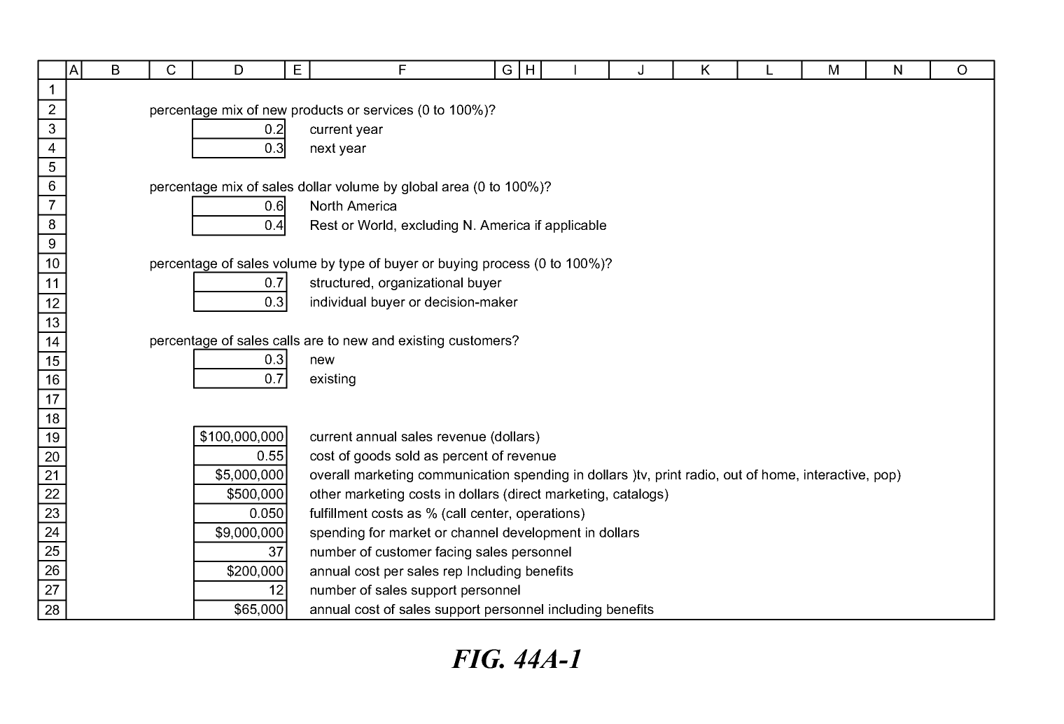

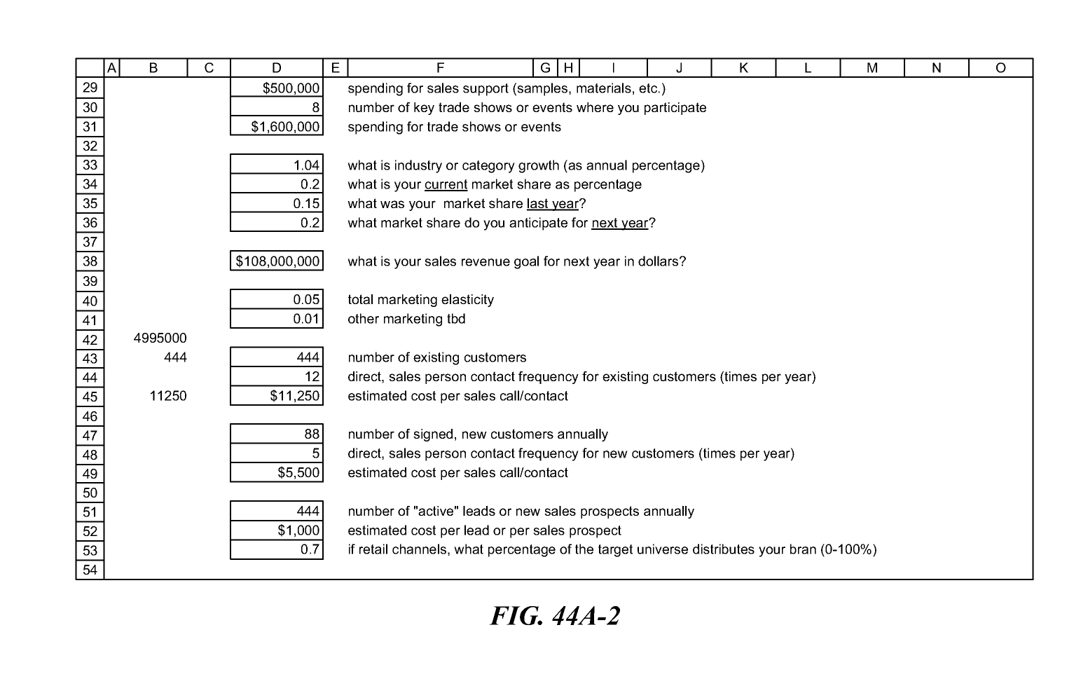

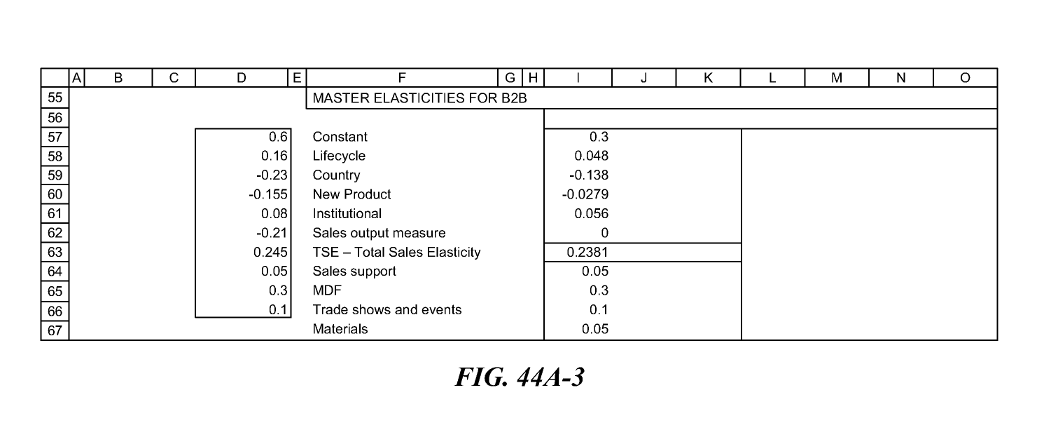

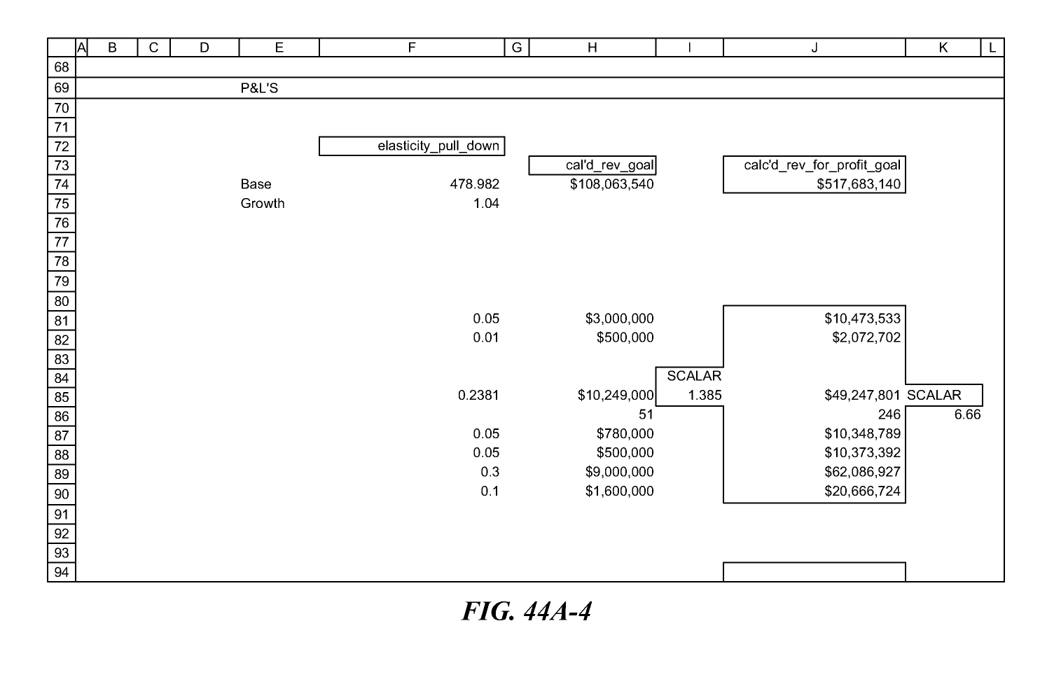

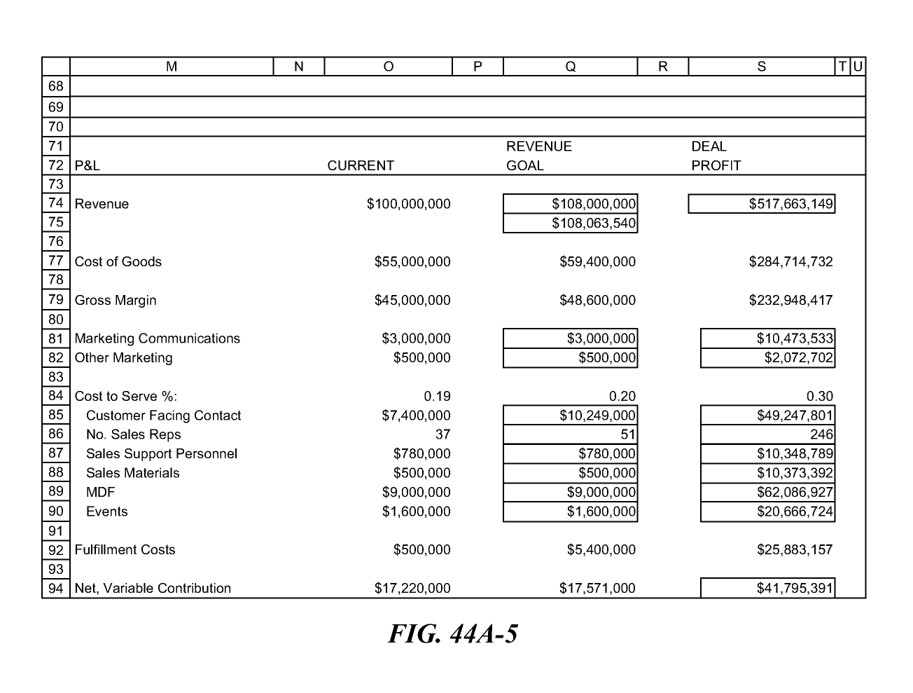

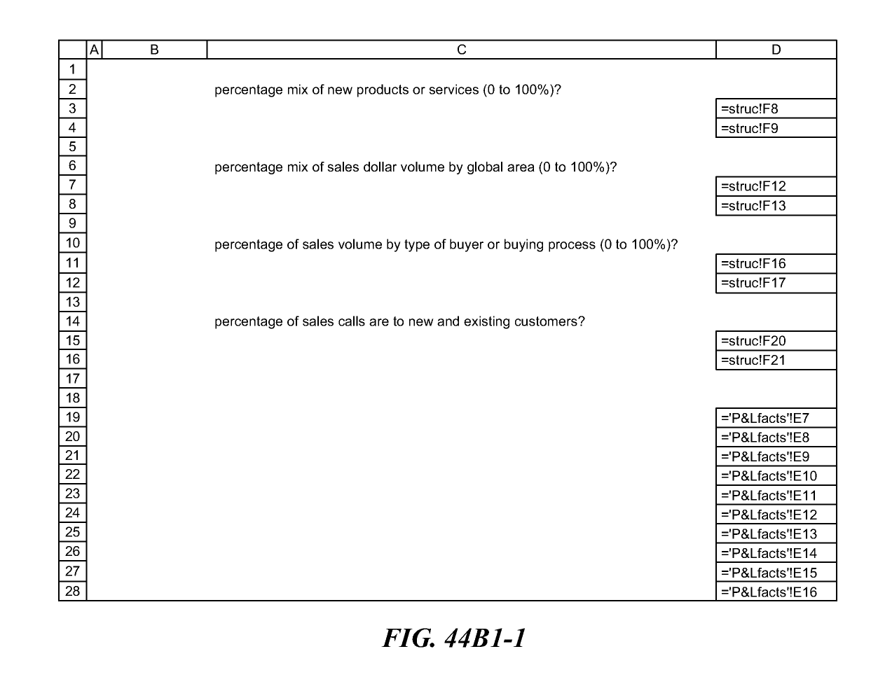

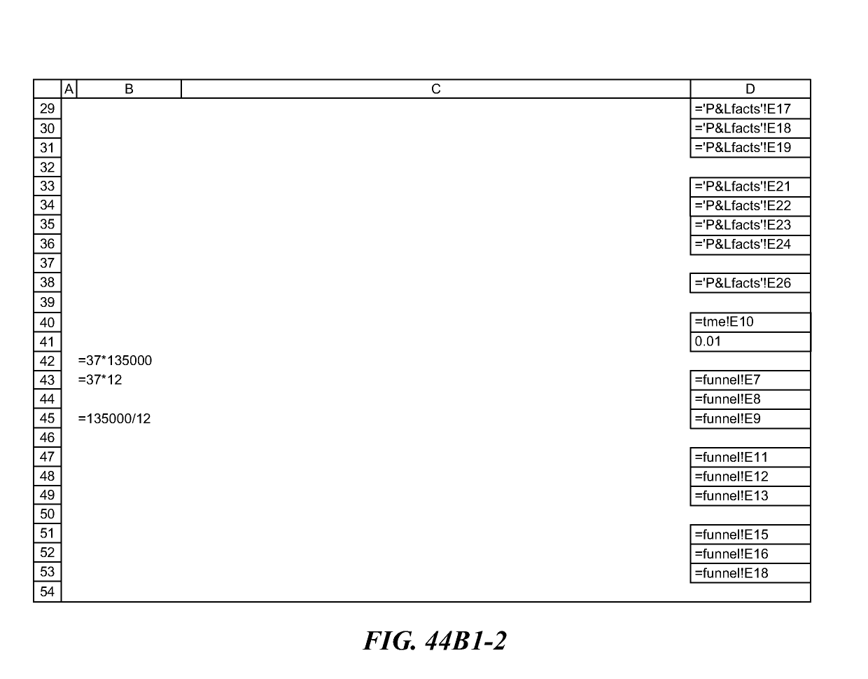

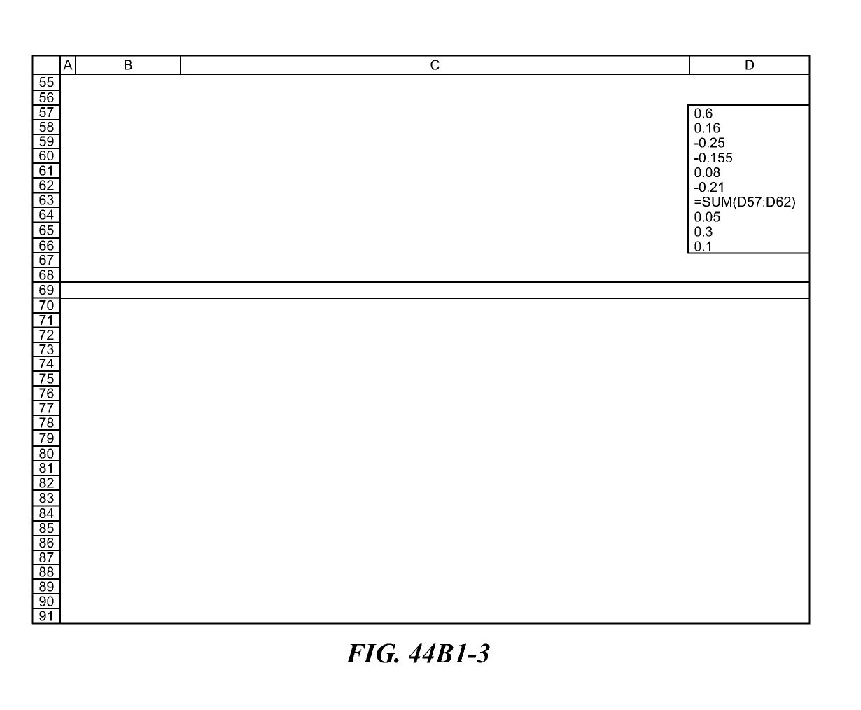

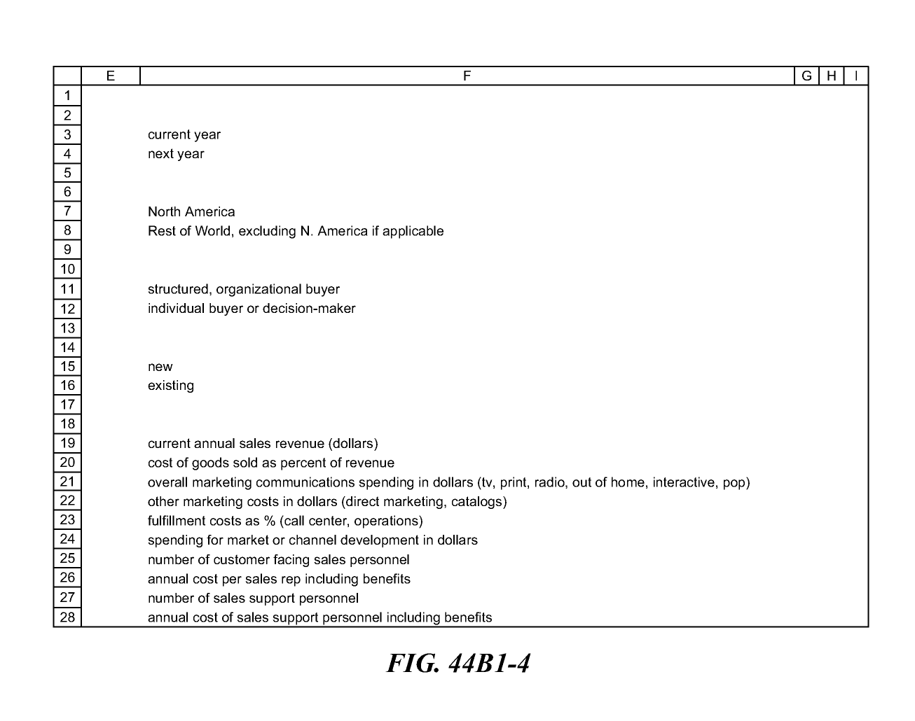

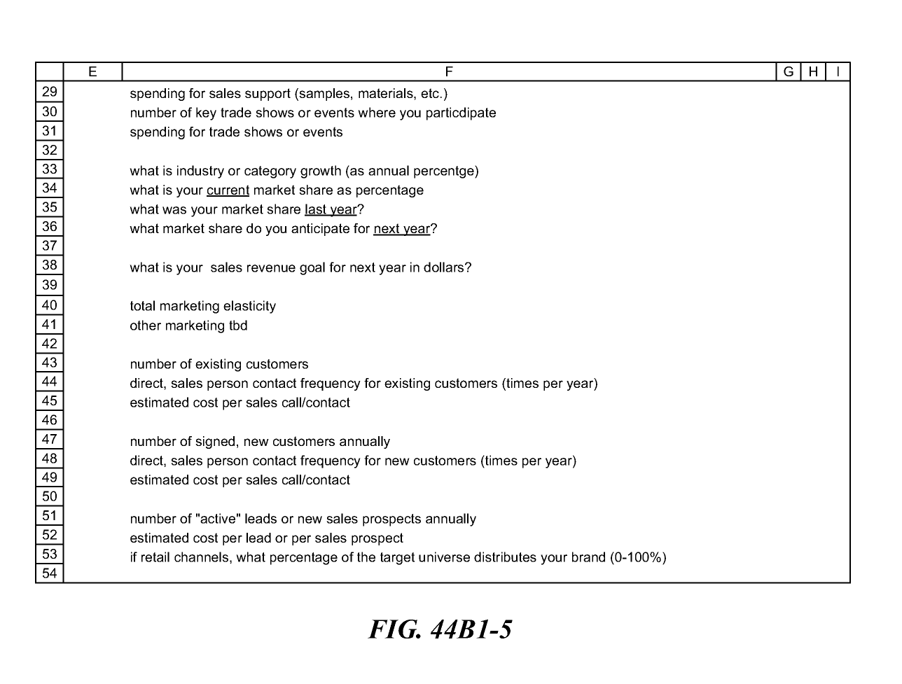

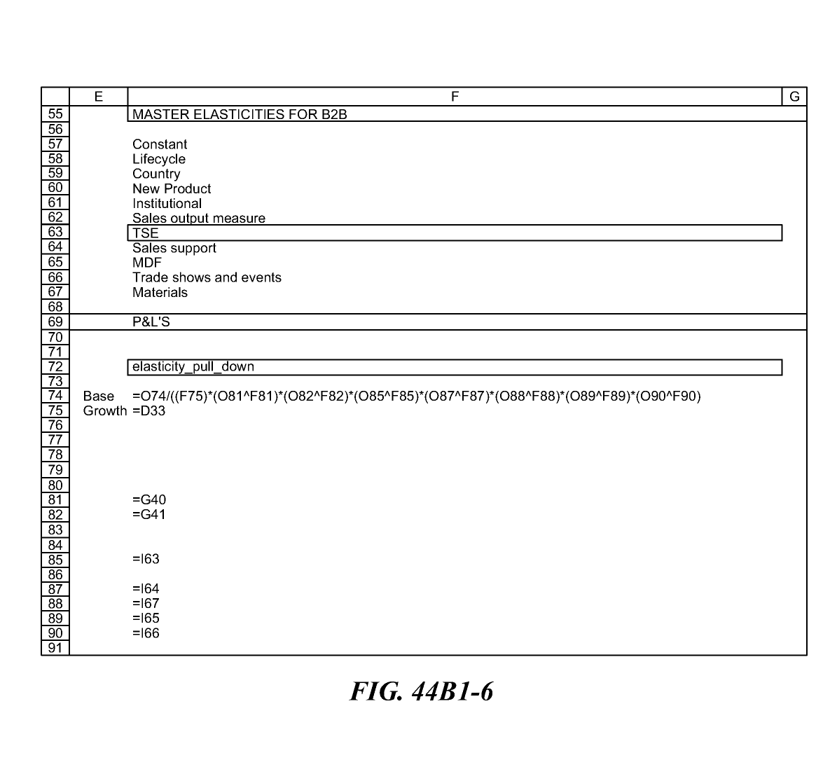

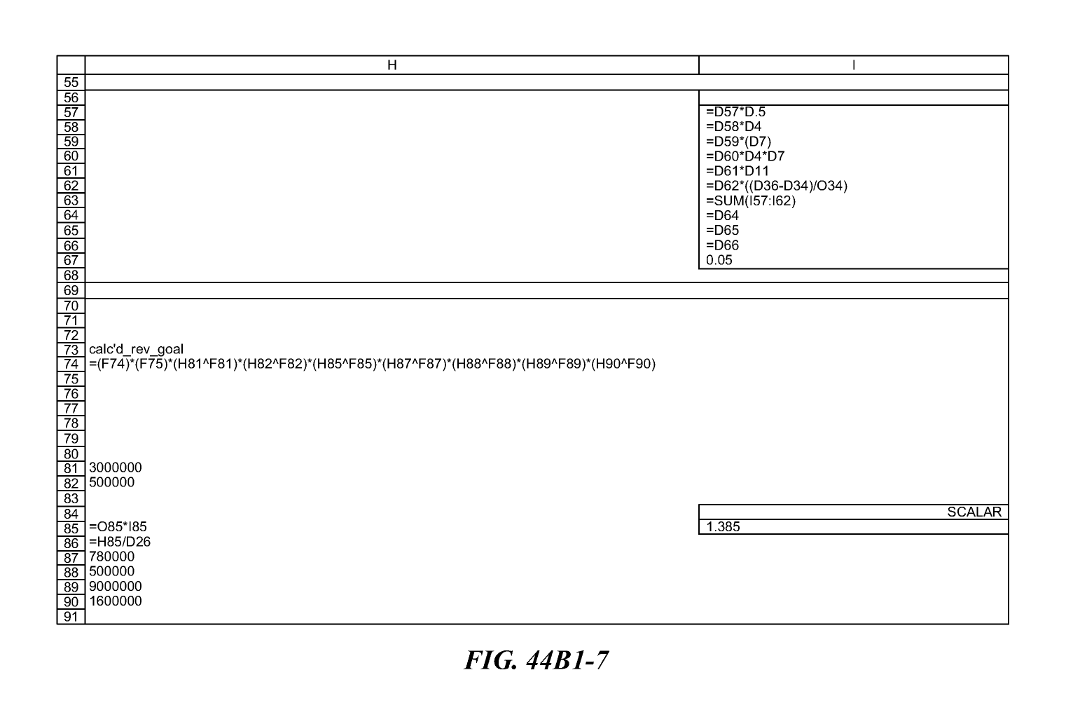

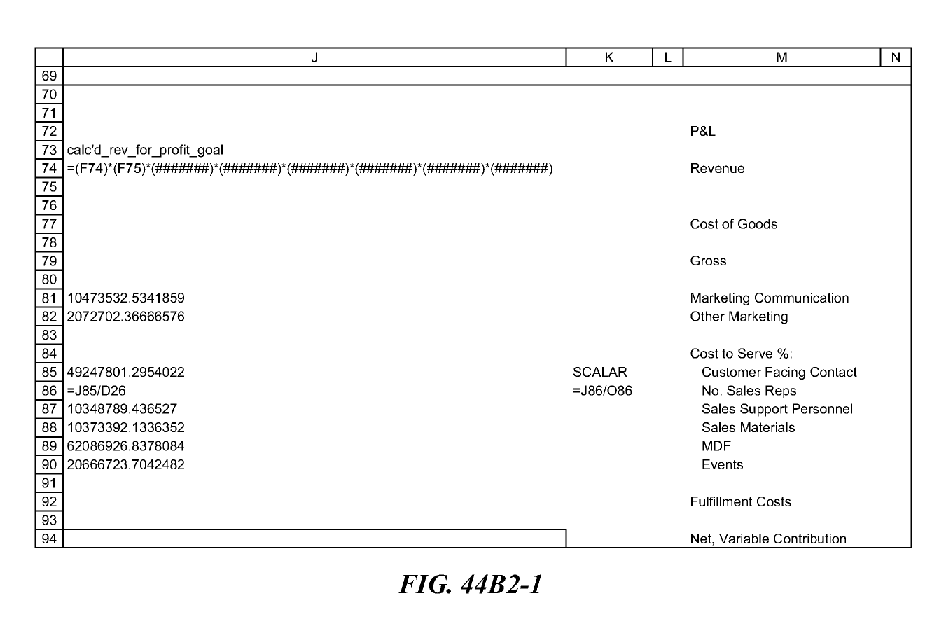

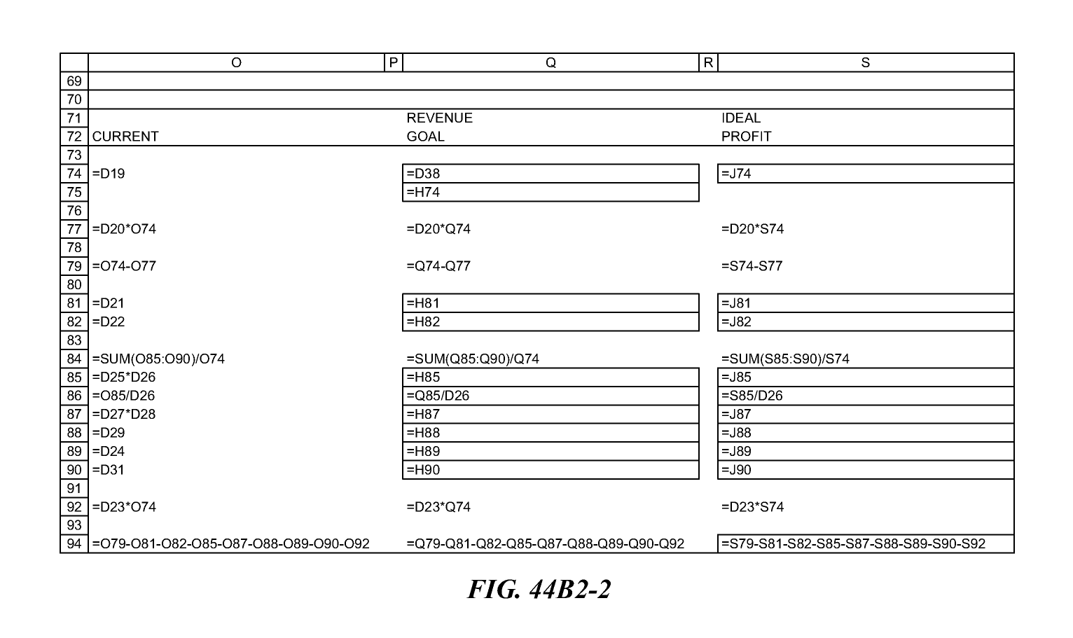

FIGS. 44A and 44B show all of the client data collected in connection with FIGS. 37-42 in cells D3-D53. In a manner similar to that described above in connection with FIGS. 33A and 33B, FIGS. 44A and 44B show the adjustment of starting elasticities in cells D57-D66 to final elasticities in cells I57-I67 for use by the facility in its optimization, in accordance with the information in cells D3-D53. In some embodiments, the starting elasticities are aggregated from across a large number of marketing studies, such as a set of 3,000 or more marketing studies collected by the Marketing Science Institute. The elasticities in F81-F90 are actually used in the optimization. The total marketing elasticity and other marketing elasticity are copied from cells D40 and D41 to cells F81 and F82, respectively. Adjusted elasticities for total sales, sales support, MDF, trade shows and events, and materials are copied from cells I63-I67 to cells F85-F90.

The facility determines an allocation of resources to salespeople, i.e., “Customer Facing Contact,” for two different scenarios: (1) to achieve a revenue goal determined by the client (solicited from the user and stored in cell D38), and (2) to maximize profit. To determine an allocation to salespeople for the first scenario, the facility uses a spreadsheet solver functionality to determine a scalar in cell I85, representing the ratio of recommended salesperson allocation to current salesperson allocation shown in cell O85. In particular, the facility solves for a value of cell I85 with the goal of reaching a value in cell H74 for projected revenue that is as close as possible to the revenue goal in cell G74. The formula for projected revenue cell H74 relies on the variable salesperson budget, driven by the sought-for scalar cell, together with the following budgets, which are held equal to their current level: marketing communications in cell H81; other marketing expenses in cell H82; sales support personnel in cell H87; sales materials in cell H88; MDF in cell H89; and events in cell H90. The determined scalar value is 1.385, which produces a suggested sales force allocation of $10,249,000, and revenue of $108,063,540, very near the $108,000,000 goal. It can be seen that the values determined in column H for the first scenario are copied into column Q for presentation.

Similarly, the details of the optimization results for the second scenario are shown for presentation in column S. It can be seen that column S constitutes a calculation of profit (i.e., “Net Variable Contribution”), based upon reducing revenue in cell S74 by costs in cells S77-S92. Both the revenue and costs in column S are based upon references to column J, where both the projected revenue in cell J74 and the sales budget scalar in cell K86 are based upon values for expenses in cells J81-J90. The facility solves for these expenses in order to maximize the profit in cell S94, which is duplicated in cell J94. The values determined for these expenses are shown in cells J81-J90, and duplicated in cells S81-S90, producing a profit of $41,795,391 as shown in cells S94 and J94, based on revenue shown in cell S74 and expenses shown in cells S77, S81, S82, S85, S87, S88, S89, S90, and S92.

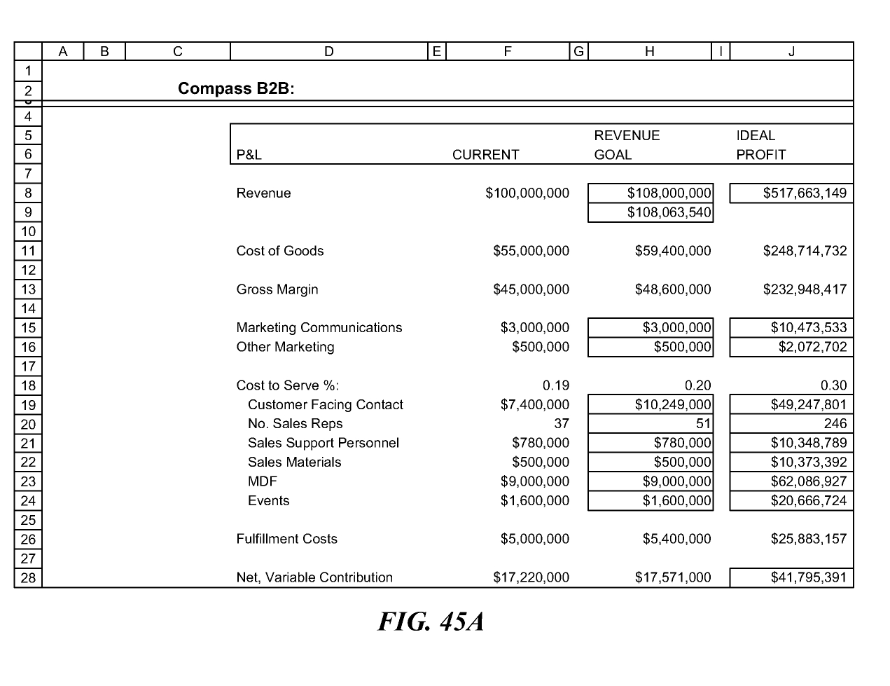

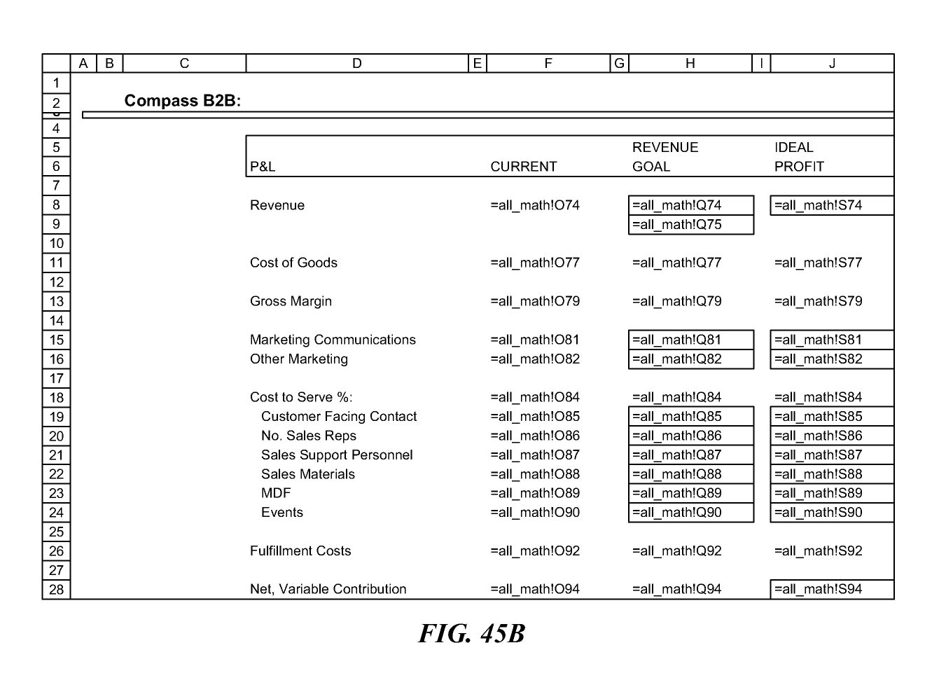

FIGS. 45A and 45B show the results of the facility's optimization for the two scenarios, copied from cells M71-S94 of the spreadsheet shown in FIGS. 44A and 44B.

It will be appreciated by those skilled in the art that the above-described facility may be straightforwardly adapted or extended in various ways.

We claim:

1. A computer-readable medium whose contents are capable of causing a computing system to perform a method for automatically prescribing a budget for sales expenses to be incurred by a distinguished organization for a distinguished offering expected to produce a selected optimization of a distinguished business outcome, the method comprising:
determining a lift factor for sales expenses based on information about the distinguished organization or the distinguished offering obtained from a user;
for each of a plurality of promotion activities other than sales expenses, determining a lift factor for the promotion activity;
establishing a relationship between the determined lift factors, budgets for the promotion activities to which the lift factors correspond, and a projected value of the distinguished business outcome; and
using the established relationship to solve for a value of the sales expenses budget that tends to optimize the projected value of the distinguished business outcome in accordance with the selected optimization.

2. The computer-readable medium of claim 1 wherein each of the lift factors is an exponential elasticity measure.

3. The computer-readable medium of claim 1 wherein the distinguished business outcome is revenue and the selected optimization is to reach a budgeted level of revenue.

4. The computer-readable medium of claim 1 wherein the distinguished business outcome is profit and the selected optimization is to maximize profit.

5. The computer-readable medium of claim 1 wherein the determined sales lift factor is composited from a plurality of constituent lift factors, the method further comprising determining, for each of the plurality of constituent lift factors, determining the constituent lift factors based on information about the distinguished organization or the distinguished offering obtained from a user.

6. The computer-readable medium of claim 1, further comprising presenting a visual user interface for soliciting the information about the distinguished organization or the distinguished offering obtained from a user.

7. The computer-readable medium of claim 1, further comprising outputting the obtained budget for sales expenses.

8. The computer-readable medium of claim 1 wherein solving for a value of the sales expenses budget comprises using the established relationship to solve for a value of the budget for at least one of the plurality of promotion activities other than sales expenses.
